(19) United States
(12) Patent Application Publication
(10) Pub. No.: US 2016/0279680 A1
(43) Pub. Date: Sep. 29, 2016

(54) Cleaning Device, Methods of Cleaning and Recipients with Cleaning Liquid

(71) Applicant: CLIRIS SA, Yverdon-les-Bains (CH)

(72) Inventor: Didier Lutz, Lutry (CH)

(21) Appl. No.: 15/032,538

(22) PCT Filed: Oct. 29, 2014
(86) PCT No.: PCT/EP2014/073250

§ 371 Date: Apr. 27, 2016

(30) Foreign Application Priority Data
Oct. 29, 2013 (EP) 13190624.0
Mar. 9, 2014 (EP) 14158455.7
Apr. 29, 2014 (EP) 14166487.0

(51) Int. Cl. B08B 3/12

(52) U.S. Cl. CPC B08B 3/12

(57) ABSTRACT

The present invention relates to a device for cleaning glasses and other objects. The device is preferably an ultrasonic cleaning apparatus comprising a cleaning tank, one or more ultrasonic generator, for producing ultrasonic waves in the tank, one or more inlet and outlet openings for guiding a cleaning liquid through a fluid channelling system comprising one or more ducts into said tank, the device comprising one or more pumps for pumping the liquid into and out of the tank, the device further comprising one or more valves. In another aspect, the invention provides a cartridge comprising a cleaning liquid, wherein the cartridge is used with or by the device. The invention further relates to method of cleaning glasses or other objects by using the device of the invention.

### TECHNICAL FIELD

The present invention relates to cleaning devices for glasses, in particular an ultrasonic cleaning device, to cartridges comprising a cleaning liquid, cartridges comprising a rinsing and/or drying liquid, and methods for cleaning glasses or other objects.

### PRIOR ART AND THE PROBLEM UNDERLYING THE INVENTION

The present invention addresses problems related to the cleaning of glasses and other small objects in general, household objects, jewellery and the like. For cleaning glasses, for example, a wearer of glasses generally uses a cleaning cloth and cleans the glasses by hand. While this type of cleaning may be suitable to remove visible dirt from the glasses and thereby improve transparency, there are several disadvantages. First of all, the manual cleaning is generally not complete in that some parts of the glasses cannot be cleaned, in particular surfaces of the glasses around the bridge of the glasses, close to the nose pads or around the articulation of the temple arms. Secondly, manual cleaning may damage delicate parts of glasses, such as the mount of the nose pad, for example. Thirdly, manual cleaning does not remove very small dirt and omnipresent microbes. Microorganisms present on the skin are generally found on all parts of the glasses.

Ultrasonic cleaning devices are known to address some of the problems of manual cleaning, and such devices are used specifically by opticians. Some of these ultrasonic cleaners are not suitable for use at home, due to the professional handling that is required for running the device. Most of these devices provide direct access to the cleaning tank without any protection with regard to the cleaning liquid, so that there is a risk of spilling the cleaning fluid present in the device. Some ultrasonic cleaning devices are used in that the optician immerses the glasses by holding it on a part of the temple arms, generally on one of the bows at the extremity of a temple arm. Therefore, the part where the glasses are held are not immersed into the cleaning liquid and thus not cleaned.

Recently, ultrasonic cleaning devices for domestic use have been developed. The user generally pours the cleaning liquid into a cleaning tank and puts the glasses into the tank thereafter. After cleaning, the glasses are removed and the cleaning liquid may be left in cleaning tank, may be poured back into a recipient of the cleaning liquid manually, or may be discarded. This is of course an inconvenient process. Even when using a funnel there is a risk of spilling the liquid. Furthermore, the cleaning liquid may stay on the glasses for some time, so that drying is required, using again a drying cloth or leaving the glasses in the open air for drying. In general, commercially available ultrasonic cleaning devices for domestic use are not user-friendly. The handling with the cleaning liquid is inconvenient. The user is not well protected from getting in contact with the cleaning liquid, in particular when adding the liquid or removing it from the cleaning tank.

There is thus a need for providing means that enable rapid and convenient cleaning of glasses, preferably without any manual manipulation of cleaning. Preferably, such a cleaning should be complete and thorough, removing macroscopic as well as microscopic dirt and killing microbes.

The present invention addresses the problems depicted above.

### SUMMARY OF INVENTION

Surprisingly, the present invention provides novel devices for conveniently cleaning glasses and other objects. The invention also provides recipients, in particular cartridges, containing a cleaning and/or rinsing liquid. The recipients are preferably adapted to be used with the devices of the invention. Furthermore, the invention provides compositions that can be used for cleaning and/or rinsing glasses and other objects.

In an aspect, the present invention provides an ultrasonic cleaning device for cleaning glasses and other objects, the device comprising a closable cleaning tank for placing the object to be cleaned and further being adapted to be branched to one or more detachable, replaceable and/or consumable cartridges comprising cleaning and/or rinsing liquids.

In an aspect, the present invention provides an ultrasonic cleaning device adapted for domestic use, the device being a device for cleaning glasses and other objects, the device comprising a closable cleaning tank for placing the object to be cleaned and further being adapted to be branched to one or more detachable, replaceable and/or consumable cartridges comprising cleaning and/or rinsing liquids.

In a preferred embodiment, the device of the invention comprises a duct system comprising ducts and pumps as well as an electronic control system for filling and emptying the cleaning tank in an automated manner with the contents of the one or more cartridges. In this manner, the device of the invention is preferably adapted to conduct an overall cleaning cycle comprising a cleaning and a rinsing and/or drying step.

In an aspect, the present invention provides a cleaning device for glasses and other objects, the device comprising a cleaning tank, one or more inlet and outlet openings for guiding a cleaning liquid through one or more fluid channeling system comprising one or more ducts into said tank, the device comprising one or more pumps for pumping the liquid into and out of the tank.

In an aspect, the present invention provides an ultrasonic cleaning device for glasses and other objects, the device comprising a cleaning tank, one or more ultrasonic generator, for producing ultrasonic waves in the tank, one or more inlet and outlet openings for guiding a cleaning and/or rinsing liquid through one or more fluid channeling system comprising one or more ducts into said tank, the device comprising one or more pumps for pumping the liquid into and out of the tank, the device further comprising one or more valves for controlling a flow of the cleaning liquid into and out of said tank.

In an aspect, the invention provides an cleaning device for glasses and other objects, comprising: a cleaning tank; one or more ultrasonic generator, for producing ultrasonic waves in the tank comprising one or more inlet and outlet openings; one or more fluid channelling system comprising one or more ducts; one or more pumps for pumping the liquid through said one or more fluid channeling system into and out of the tank, one or more electronic controller for operating said ultrasonic generator, and said one or more pumps; and, a housing and/or casing; wherein said device is further adapted to be connected to one or more cartridges for branching said liquid channeling system with cleaning and/or rinsing liquids contained in said one or more cartridges.

In an aspect, the device comprises a housing and/or casing, wherein a cleaning tank, one or more liquid channeling system, one or more pumps, one or more valves, one or more ultrasonic generator and one or more electronic controllers are housed inside said housing and/or casing.

In an aspect, the invention provides a cartridge comprising cleaning liquid.

In an aspect, the invention provides a cartridge comprising a rinsing and/or a drying liquid.

In an aspect, the invention provides a cartridge comprising a cleaning liquid and a rinsing or a drying liquid. In an embodiment, the invention provides a cartridge comprising two compartments, one compartment comprising a cleaning liquid and the other compartment comprising a rinsing/drying liquid.

In an aspect, the invention provides a cartridge comprising a cleaning and/or rinsing liquid for a cleaning device, preferably an ultrasonic cleaning device, said cartridge comprising one or more openings for connecting and/or branching the cartridge with said cleaning device.

In an aspect, the invention provides cartridges for use with the device and/or in the methods of the invention.

In an aspect, the invention provides a cartridge for cleaning and/or rinsing liquid for the cleaning device of the invention, said cartridge comprising one or more connectors and/or openings.

In an aspect, the invention provides a cartridge for cleaning and/or rinsing liquid for the cleaning device of the invention, said cartridge comprising one or more opening comprising a self-closing valve.

In an aspect, the invention provides a cartridge for cleaning and/or rinsing liquid for the ultrasonic cleaning device of the invention, said cartridge comprising one or more opening comprising a self-closing valve.

In an aspect, the invention provides a cartridge containing a cleaning and/or rinsing liquid for the ultrasonic cleaning device of the invention, said cartridge comprising one or more openings, wherein said opening comprises a self-opening valve, said valve being adapted to open when a connector is connected to said opening.

In an aspect, the invention provides a cartridge for cleaning and/or rinsing liquid for a cleaning device, said cartridge comprising one or more openings for connecting the cartridge with the device of the invention, wherein said cartridge comprises two separate compartments, a first compartment and a second compartment, wherein said first and second compartments comprise different liquids.

In an aspect, the invention provides a cartridge comprising two separate compartments, a first compartment and a second compartment, said cartridge comprising two separate openings through which liquid in said compartments can be removed, wherein said first compartment comprises a first liquid, said first liquid being a cleaning liquid for an ultrasonic cleaning device and said second compartment comprises a second liquid, said second liquid being a rinsing and/or drying liquid.

In an aspect, the invention provides a kit comprising two cartridges, a first cartridge and a second cartridge according to the present invention, wherein said first cartridge comprises an aqueous solution of one or more a cleaning agent and said second compartment comprises an aqueous solution comprising an alcohol.

In an aspect, the invention provides methods for cleaning glasses and other objects using the device, cartridge and/or compositions of the invention.

In an aspect, the invention provides a method for cleaning glasses or other objects, the method comprising the steps of:
pumping a cleaning liquid through one or more fluid channeling system or duct into a cleaning tank of the cleaning device of the invention, wherein an object to be cleaned is present and/or has previously been placed to the cleaning tank;
cleaning the object by the and/or in presence of said cleaning liquid; and,
pumping said cleaning liquid out of said cleaning tank.

In an aspect, the invention provides a method for cleaning glasses or other objects, the method comprising the steps of:
pumping a cleaning liquid through one or more fluid channeling system or duct into a cleaning tank of an ultrasonic cleaning device comprising an object to be cleaned;
applying an ultrasonic treatment so as to clean said object;
pumping said cleaning liquid out of said cleaning tank.

Further aspects and preferred embodiments of the invention are defined herein below and in the appended claims.

Further features and advantages of the invention will become apparent to the skilled person from the description of the preferred embodiments given below, which illustrate the invention without limiting its scope.

### BRIEF DESCRIPTION OF THE DRAWINGS

FIG. 1 is a schematic representation of first embodiments of the device and of a cartridge, respectively, of the invention.

FIG. 2 shows schematic representations of other embodiments of the device and the cartridge of the invention.

FIG. 3 is a schematic representation of further embodiments of the device and the cartridge of the present invention.

FIG. 4 is a schematic representation of yet other embodiments of the device and the cartridge of the present invention.

FIG. 5 is a schematic representation of still other embodiments of the device and the cartridges of the present invention.

FIG. 5a is a schematic representation of still other embodiments of the device and the cartridges of the present invention.

FIG. 6 is a schematic representation of other embodiments of the device and the cartridges of the present invention.

FIG. 7 is a schematic representation of other embodiments of the device and the cartridges of the present invention.

FIG. 8 is a schematic representation of other embodiments of the device and the cartridges of the present invention.

FIG. 9 schematically represents an embodiment of the cleaning tank of the device of the present invention.

FIG. 9a schematically represents another embodiment of the cleaning tank of the device of the present invention.

FIG. 10 schematically represents an embodiment of the cleaning tank and its lid in accordance with an embodiment of the device of the present invention, the lid being shown in an open position.

FIG. 11 is as FIG. 10, with the lid being shown in a closed position.

FIG. 12 schematically represents an embodiment of the invention including a housing and a pivotable cleaning tank, the tank being closed.

FIG. 13 is as FIG. 11, the cleaning tank being open.

FIG. 14 shows a cleaning tank and an insert in accordance with an embodiment of the invention.

FIG. 15 shows an empty cleaning tank according to an embodiment of the invention.

FIG. 16 shows the embodiment of FIG. 15, the cleaning tank being filled with a cleaning fluid.

FIGS. 17 and 18 schematically represent the docking and/or connection of the cartridges of the invention to the liquid channelling system of the device of the invention.

FIGS. 18a and 18b schematically represent an embodiment of an pressure balancing opening or air opening in the cartridge of the invention.

FIG. 19 is a perspective view of a cleaning device according to an embodiment of the invention.

FIG. 20 is a perspective view of the device of FIG. 19, with the cleaning tank being opened.

FIG. 21 is a lateral elevation view of the device of FIGS. 19-20, with the cleaning tank being opened.

FIG. 22 is a perspective view of the rear of the device of FIGS. 19-21, with a lid for cartridges being opened.

FIG. 23 is a combined perspective and section view of the device of FIGS. 19-22.

FIG. 24 is a combined perspective and section view of the device of FIGS. 19-23, with the lid for the cartridges being closed.

FIG. 25 is a combined rear perspective and section view of the device of FIGS. 19-24, with the cleaning tank being opened.

FIG. 26 is a combined front perspective and section view of the device of FIGS. 19-25, with the cleaning tank being opened.

FIG. 27 is a section view of the device of FIGS. 19-26, with the cleaning tank being opened.

FIG. 28 is an extract of FIG. 27.

FIG. 29 is a rear perspective view of the device of the invention, with the cartridges being removed.

FIGS. 30 A-30 B are different views of a cartridge in accordance with an embodiment of the invention.

FIG. 31 is a schematic representation of a duct system in accordance with an embodiment of the invention.

### DETAILED DESCRIPTION OF THE PREFERRED EMBODIMENTS

The present invention concerns, in some aspects, a device for cleaning glasses and other objects. The expression “glasses”, for the purpose of this specification, encompasses all types of ophthalmic appliances, such as corrective appliances such as eyeglasses and spectacles, but also non-corrective appliances, for sunglasses, shades, and appliances that may be both, corrective and non-corrective and which may or may not comprise a UV protection. The expression “glasses” preferably encompasses all types of appliance comprising an at least partially transparent medium such as glass or plastic to be carried by a human subject, wherein the appliance is used by the subject by glaring and/or viewing the subject's environment across the at least partially transparent medium.

For avoiding any doubts it is clarified that the term “glasses” is not intended to mean that the appliances necessarily need to comprise or consist essentially of glass. If the “glasses” comprise lenses, the latter may be made from and/or comprise plastic material, for example.

The expression “other objects”, for example in the larger expression “for glasses and other objects”, encompasses objects that can be put into the cleaning tank and thus be cleaned by the device and methods of the invention. Preferably, the objects are not susceptible to the contact with water and/or other liquid compositions. For example, if the “object” is a watch, for example a wrist-watch, the latter is preferably water resistant. Other objects may be jewellery, watches, medical equipment, household objects and the like. For example, cutlery and/or silverware may be “objects” that can be cleaned with the device of the invention. In an embodiment, the device of the invention can be used for cleaning glasses, jewellery, watches and medical equipment, which all are encompassed by the expression “other objects”.

In general, the expression “other objects” encompasses any object that is small enough to fit into the cleaning tank of the device of the invention and which is preferably not damaged when being exposed to and/or immerged in any one of the cleaning and/or rinsing liquids that may be used in the context of the uses, methods, devices and cartridges of the present invention.

In a preferred embodiment, the device of the invention is designed and/or adapted for home and/or private use. In particular, the device of the invention is adapted to domestic use, as opposed to industrial use. Preferably, the device is not adapted to an industrial context. The device is adapted to be used by a user that is not required to have a particular knowledge of the cleaning and/or liquid liquids and without particular knowledge in the area of ultrasonic cleaning, for example. The device is preferably designed so that a normal consumer, for example an adult user or even a child, can operate it in order to clean one's glasses. Preferably, the device of the invention is adapted to the cleaning of eyeglasses comprising a pair of lenses and a pair of temples.

The device of the invention is preferably configured and adjusted as an electric or electronic apparatus for use in a household. In an embodiment, the device of the invention is a household and/or domestic electrical apparatus. Preferably, the device can be branched via a cable (not shown) to an electric power supply of the household, typically 110V or 220V. The device of the invention preferably comprises a transformer or battery 12, for example a rechargeable battery that can function as supply of electric energy for the device of the invention.

In a preferred embodiment, the device of the invention is an ultrasonic treatment apparatus. In other embodiments, the device does not use ultrasonic treatment for cleaning.

While some ultrasonic cleaning devices for home use are known, such devices are not convenient to use. The user has to insert cleaning solutions, for example from a bottle containing the cleaning solution, into the tank and may thus come easily in contact with said cleaning solutions. This applies in particular when the dirty cleaning solution has to be manually removed after cleaning. Furthermore, ultrasonic devices that are designed for home, private, or more generally, non-industrial use do generally not provide for a possibility of having the glasses dried. This applies also for ultrasonic cleaning apparatuses used by opticians, which generally require manual drying, generally using a towel, after ultrasonic cleaning. The present invention is preferably not related to the area of sterilization of medical or scientific equipment, such as surgical tools or other medical, laboratory and/or scientific tools. The device of the invention is preferably not adapted to warrant a particular sterility assurance level.

In an embodiment, the device is designed for domestic use, to be used by an individual at home or at work. In other embodiments, the device is used commercially, for example in commercial cleaning methods. For example, the device is used by an optician and/or a pharmacist who offers the cleaning of glasses and other objects to clients.

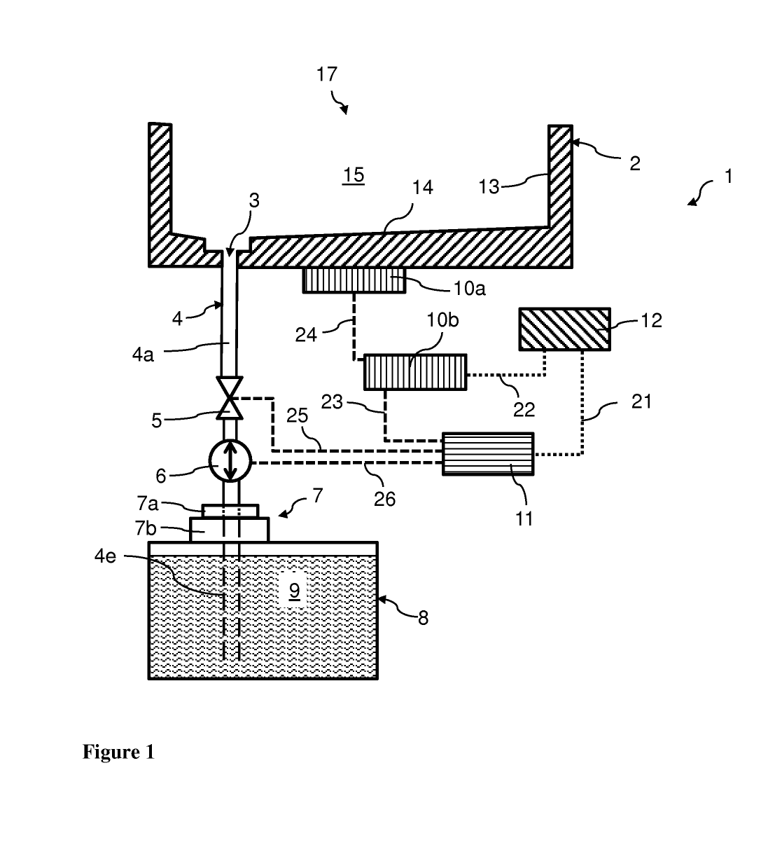

FIG. 1 schematically shows a first embodiment of the cleaning device 1 and the cartridge 8 of the invention. The cleaning device comprises a cleaning tank 2 comprising a lumen or inner volume 15 in which cleaning can take place. The cleaning tank 2 comprises inner side walls 13 and a bottom wall or surface 14, defining the volume of the tank. The tank comprises an inlet and/or outlet in the form of an opening 3. Cleaning and/or rinsing liquid 9 enters and/or leaves the cleaning tank 2 through the inlet and/or outlet 3.

The device of the invention comprises one or more liquid channeling system or duct system 4. The liquid channeling/duct system comprises tubes, ducts, tube sections 4a and generally further comprises one or more pumps 6 and/or one or more valves 5. In the embodiment shown in FIG. 1, the device comprises one bidirectional pump 6 and one valve 5, which may be a two-way valve.

The channeling system 4 provides for a connection between the tank 2 and the cartridge 8, allowing a communication between the compartment of the tank and the cartridge. In particular, the liquid channeling system 4 allows for controlled transport of liquid from the cartridge 8 to the tank and vice versa.

The connector 7a is also part of the liquid channeling system 4. The connector 7a is adapted to connect the device of the invention 1, and in particular the duct system 4, to the cartridge 8. In this regard, the cartridge 8 comprises also a connector 7b, adapted to be connected with connector 7a. Connectors 7a and 7b of the liquid channeling system and the cartridge, respectively, are part of the connection assembly 7. The connection assembly allows a water proof connection of the inside of the duct system 4 with the inside of the cartridge. Connectors 7a and 7b are adapted to be connected to each other, for example via a female-male connection system. Connector 7b is associated with the opening of the cartridge. Therefore, reference numeral 7b also refers to the opening of the cartridge. The opening 7b preferably comprises a connector, allowing connection with the connector 7a of the liquid channeling system.

As the skilled person will understand from the foregoing, the device of the invention is adapted to and/or capable of pumping the liquid contained in the cartridge into the cleaning tank and back from the cleaning tank into the cartridge. The valve 5 interrupts and/or blocks liquid flow when required, for example to prevent liquid 9 to flow back to the cartridge after having been pumped into the tank.

The device of the invention further comprises one or more ultrasonic generators and/or ultrasonic transducers 10a. In the embodiment shown, the ultrasonic transducer 10a is activated, deactivated and/or more generally controlled by the ultrasonic unit 10b. While there is only one ultrasonic transducer 10a shown in FIG. 1, the invention encompasses that the device of the invention comprises two or more, for example 2, 3, or 4 ultrasonic transducers. This applies to all embodiments described in this specification. In other embodiments, the invention encompasses that ultrasonic transducers and ultrasonic units are entirely absent. In this case, cleaning is achieved by the cleaning liquid 9 in the absence of ultrasonic treatment.

The device of the invention further comprises one or more electronic controller 11. Preferably, the electronic controller is a micro-controller, comprising, for example, one or more data processing units, preferably microprocessors. In the embodiment shown, the controller 11 controls the ultrasonic unit 10b, the valve 5 and the pump 6.

In an embodiment, the device of the invention comprises a power supply 12 for providing electric energy to one or more selected from said ultrasonic generator, electronic controller, one or more pumps and said one or more valves.

A power supply 12 provides power of required voltage to the controller 11, the ultrasonic unit and other constituents of the device as required. In this regard, reference numerals 21 and 22 represent electric current cables. Reference numerals 23, 24, 25 and 26 refer to cables that communicate instructions and/or current as applicable. Accordingly, the controller 11 may activate pump 6 by activating a pump driver (not shown) that may have its own power source, or by directly providing power to the pump and thus activating it, for example.

The controller 11 may activate valve 5 by activating a valve driver (not shown) that may have its own power source, or by directly providing power to the pump and thus activating it, for example. The power of pump and/or valve drivers, as applicable, may also be provided by power supply 12, for example.

The device of the invention is operated as follows: If a user wishes to clean his and/or her glasses (or another object), the latter are placed into the cleaning tank. The cleaning tank preferably contains a holder device 35 (FIG. 14), which supports the glasses and which prevents the glasses from being in direct contact with the bottom surface 14 and/or inner side surfaces 13 of the cleaning tank. At that moment, the cleaning tank 2 is substantially or totally free of any fluid, in particular free of the cleaning and/or rinsing liquid as described elsewhere in this specification.

In an embodiment, valves, pumps, ultrasonic units/generators, sensors, closures, and/or other electric and/or electronic components of the device of the invention are controlled, operated and/or coordinated by the one or more electric controller 11. Preferably, the electronic controller is programmed and/or susceptible of being programmed to conduct the protocols and/or cleaning processes as described in this specification, in particular herein below.

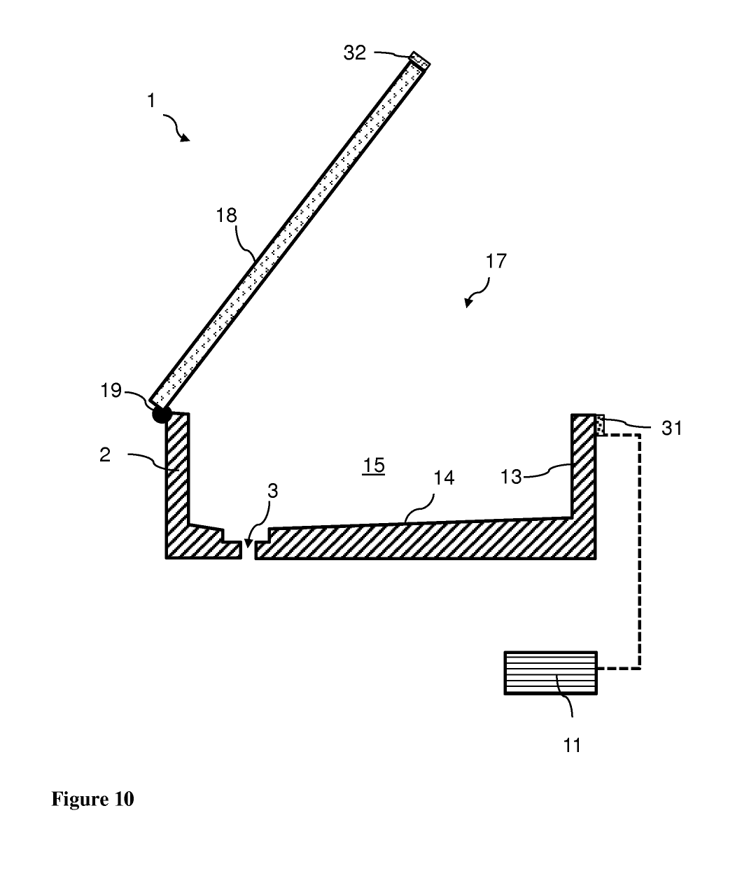

Preferably, the device comprises a lid, not shown in FIG. 1 (see FIGS. 10-13). Once the lid is closed, the electronic controller makes sure that valve 5 is in an open position and induces pump 6 to pump the cleaning liquid 9 from the cartridge through the liquid channelling system 4 into the cleaning tank. When the tank is filled to its maximum permissible filling level, the controller 11 instructs valve 5 to close and switches off pump 6. Then, the one or more ultrasonic transducers 10a are induced to produce ultrasound inside the cleaning tank 2. In this regard, it is noted that the ultrasonic generator 10a is in contact with the outside of a side or bottom wall of the cleaning tank and is thus arranged to effectively produce ultrasound inside the tank. Thanks to the composition of the cleaning liquid and to the ultrasound, the glasses that are present in the tank are completely and effectively cleaned. The ultrasound destroys in particular microbes and even small particles of dirt.

The ultrasound treatment is preferably produced regularly and/or continuously. The ultrasound treatment is preferably conducted for a determined period, preferably 10 seconds to 10 minutes, preferably 20 seconds to 6 minutes, more preferably 30 seconds to 4 minutes, and most preferably for 45 seconds to 3 minutes.

After the determined ultrasonic treatment period, the controller 11 is programmed to stop the ultrasound generation by the ultrasonic unit and/or transducer, opens valves 5 and activates pump 6, this time in the other direction, so that the cleaning liquid is again transported back into the cartridge 8. When all liquid has been pumped out of tank 2, the valve 5 is preferably closed.

At this moment the cleaning process is terminated, the user can open the lid of the device and remove the glasses, now perfectly cleaned. It is noted that the user has not been at any risk to be in contact with the cleaning liquid during the entire cleaning process.

The cleaning process may be activated by the user. For example, once the user has put his glasses into the cleaning tank, he/she may actuate a button or switch, which starts the cleaning protocol. In a preferred embodiment, the cleaning process is started automatically. In particular, the device may be equipped with a sensor (not shown), which senses whether or not an object is present in the cleaning tank. Another sensor (not shown) may be provided to check whether the lid is open or closed. In case the controller receives information from the sensors that the lid is closed and an object is present in the tank, the cleaning process as described above or elsewhere in this specification is started and executed automatically, including the pumping back of the cleaning fluid into the cartridge.

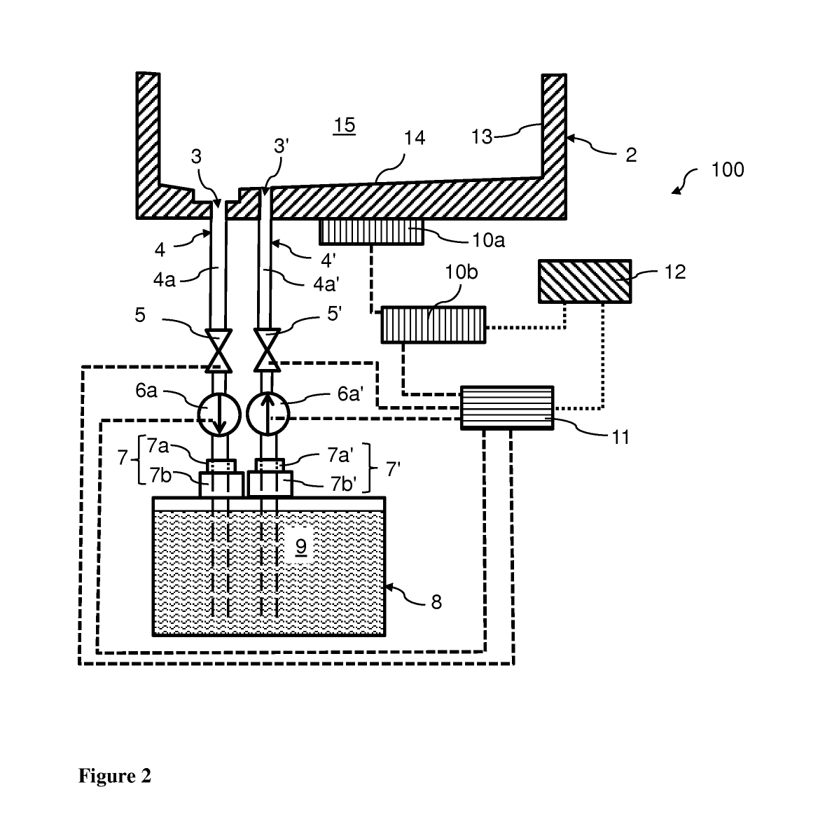

FIG. 2 shows another embodiment of the device 100 of the invention. The device of FIG. 2 differs from the one shown in FIG. 1 in that it comprises two separate liquid channelling systems 4, 4′, one 4′ adapted to pump the cleaning liquid 9 from the cartridge into the cleaning tank and the other 4 being adapted to pump the liquid from the cleaning tank 2 into the cartridge 8. Accordingly, there is a second opening 3′ in the cleaning tank, which functions as inlet, whereas opening 3 functions as liquid outlet. Furthermore, instead of bidirectional pumps, monodirectional pumps 6a and 6a′ are used, as each pump pumps the liquid 9 in one direction only.

The two liquid channelling systems 4, 4′ each comprises its own connector 7a, 7a′, matching a corresponding connector 7b, 7b′, respectively, on the cartridge 8. There are thus two connectors 7b, 7b′ on the cartridge. There are thus two connection assemblies 7, 7′, one assembly 7′ adapted to allow taking out liquid from the cartridge 8 and the other adapted to letting the liquid back into the cartridge. Each liquid channelling system 4, 4′ comprises its own valve 5, 5′. In summary, the embodiment of FIG. 2 comprises two separate liquid channelling systems 4, 4′, one 4′ for transporting liquid from the cartridge to the tank and a second, separate channelling system 4, for transporting liquid from the tank to the cartridge. In this embodiment, the liquid flows only in a single direction through each of the channelling systems 4, 4′.

As the embodiment of FIG. 2 comprises two pumps 6a, 6a′ and two valves 5, 5′, it is clear that there are connections, shown as dotted lines in FIG. 2, from the controller 11 to each pump and each valve.

As the skilled person will understand, during operation of the device 100 of the embodiment represented in FIG. 2, the valve of one of the liquid channelling systems will be closed when liquid is transported through the other liquid channelling system and vice versa. For example, valve 5 is closed (and valve 5′ open) when liquid is transported through system 4′ from the cartridge to the tank, whereas valve 5 is open (and valve 5′ closed) when liquid is pumped from the tank to the cartridge. In other words, liquid is pumped only through one system 4 or 4′ at one time.

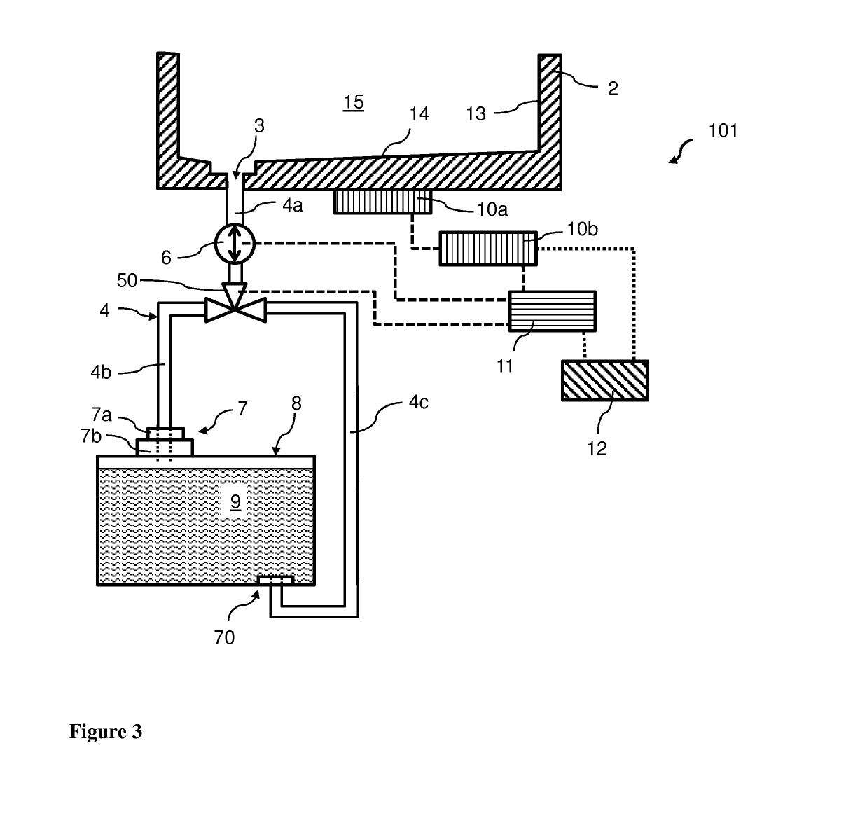

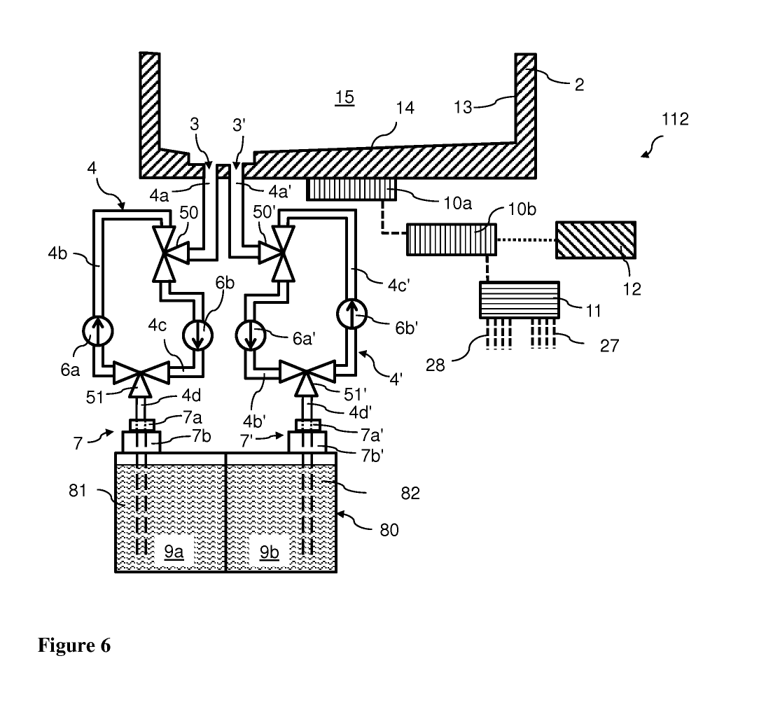

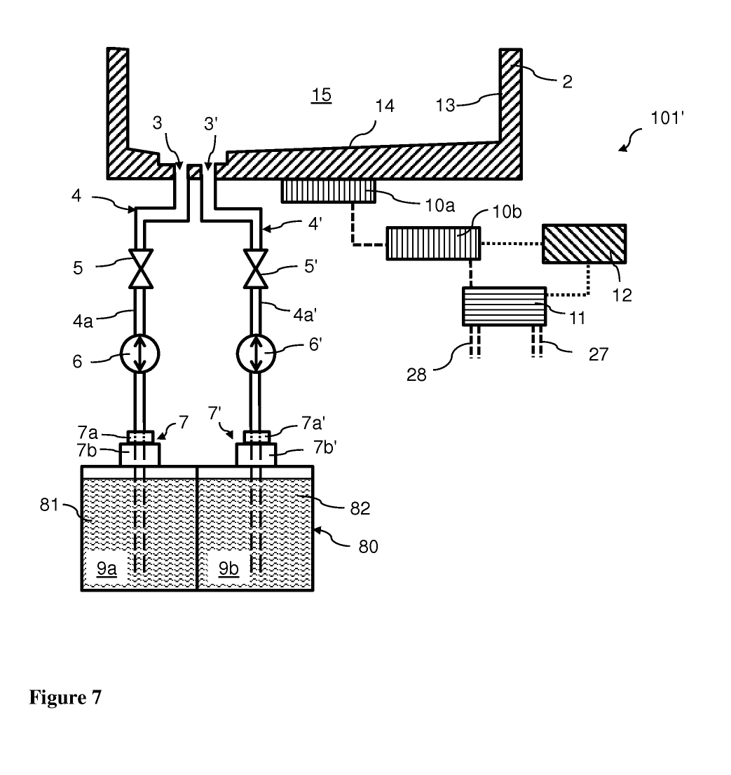

In the embodiment of the device and cartridge shown in FIG. 3, the cartridge has two separate openings and/or connectors. In particular, a first connection assembly 7 is provided at the top one of cartridge 8, and a second connection assembly 70 is provided at the bottom of the cartridge 8. Connection assembly 7 comprises two connectors 7a and 7b, provided on the end of the tube 4b and on the cartridge 8, respectively, as shown in previous embodiments (FIGS. 1 and 2). The second connection assembly 70 comprises a self-closing valve as known from water tanks in typical espresso machines. The valve in assembly 70 is opened by positioning the cartridge on a rigid connector (not shown) fixed on the housing of the device. The self-opening may be, for example, a spring-based water tank inlet valve, as used in espresso machines with removable water tanks, for example. An exemplary valve assembly of this type is disclosed in US2005/0247204A1. Of course, the invention encompasses the presence of only one connection assembly of the type of the second connection assembly 70 on one cartridge (for example, using assembly 70 on the cartridge shown in FIG. 1). The invention also encompasses one or two connection assemblies of the type 70 shown in FIG. 3 with cartridges comprising two compartments, as shown in FIGS. 6 and 7, for example.

The embodiment of FIG. 3 differs from the one shown in FIG. 2 in particular in that two completely separated liquid channelling systems are absent. A multi-way valve 50, in particular a three-way valve, receives tubes 4b and 4c, which are linked to the two separate connection assemblies 7 and 70, respectively. From three-way valve 50, a single duct 4a is guided via the bidirectional pump 6 to the combined inlet/outlet opening 3. During liquid transport, the valve 50 and pump 6 are preferably activated so that liquid flow is controlled as follows: during filling of the tank, valve 50 opens and/or connects tubes 4c and 4a, so that pump 6 pumps liquid from the cartridge into the tank. At this moment, liquid flow through tube 4b is closed at valve 50. After cleaning, valve 50 opens the channel from tube section 4a to 4b and closes the way to tube 4c, so that pump 6 can now pump the liquid 9 from the tank through tube 4b and connection assembly 7 back into the cartridge.

As the skilled person will understand, the two-channel system 4, 4′ of FIG. 2 can be combined with the two different connection assemblies shown in FIG. 3, or the two assemblies 7, 70 of FIG. 3 can be used in a device comprising two separate channelling systems 4, 4′ as shown in FIG. 2, for example.

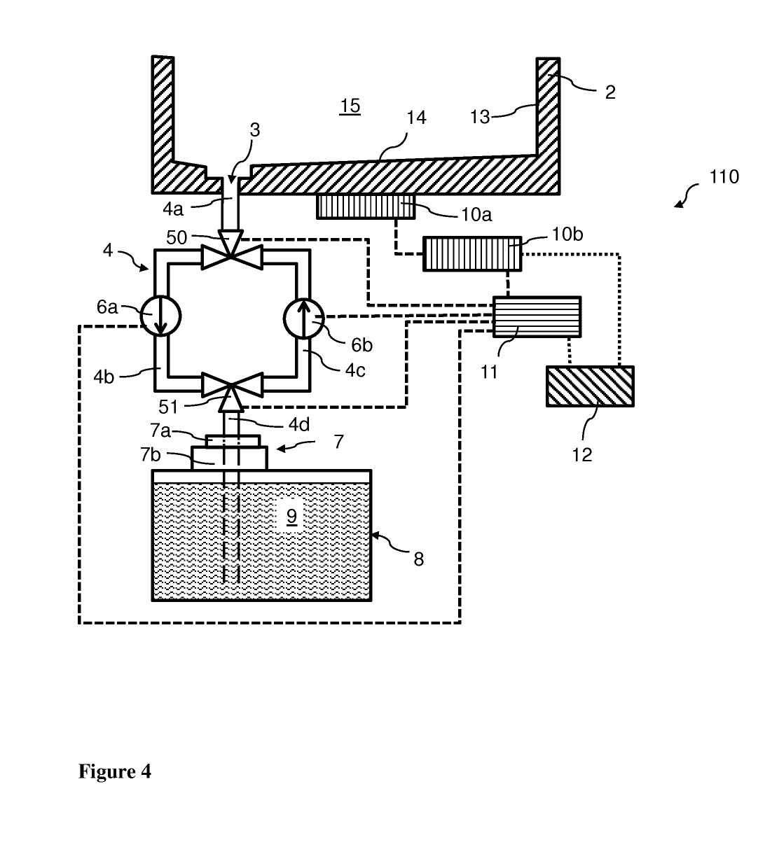

The embodiment of the device and cartridge shown in FIG. 4 is a variation of the embodiment shown in FIG. 1, for example. The bidirectional pump 6 of FIG. 1 is replaced by two separate monodirectional pumps 6a and 6b. There still is a single liquid channelling system 4, but two multi-way (in particular three-way) valves 50, 51 are arranged to provide separate liquid channels 4b and 4c, which guide liquid flow during emptying and filling tank 2, respectively. The action of the two three-way valves 50 and 51 is coordinated so that liquid can flow from the cartridge over valve 51 through tube section 4c, valve 50 and tube 4a into the tank 2. For emptying the tank, liquid is guided through tube or tube section 4a via valve 50 through tube 4b and via valve 51 through tube 4d back into the cartridge. When there is no liquid transport, during cleaning or when the device is not used, one or both valves 50, 51 may be closed completely, or at least passage through tube 4a (valve 50) and/or tube 4d (valve 51) may be closed. Since the separate tube sections 4b and 4c for guiding liquid to the cartridge and to the tank, respectively, are joined at valve 50, only one inlet/outlet opening 3 is provided. In the same line (but independently), since the separate tube sections 4b and 4c for guiding liquid to the cartridge and to the tank, respectively, are joined at valve 51, only one connection assembly 7 is required.

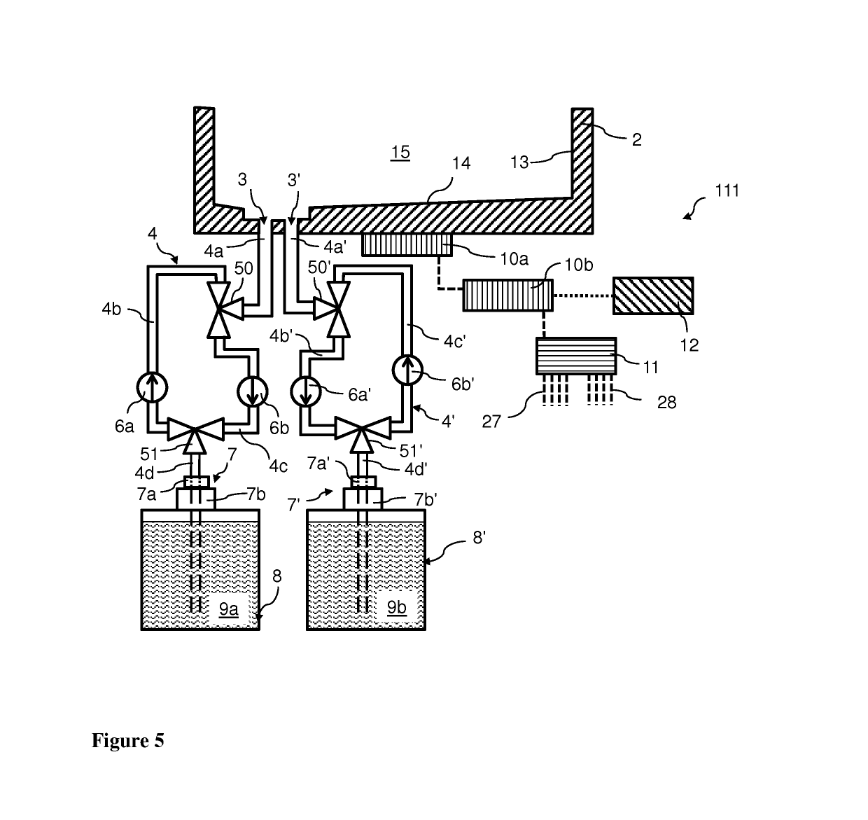

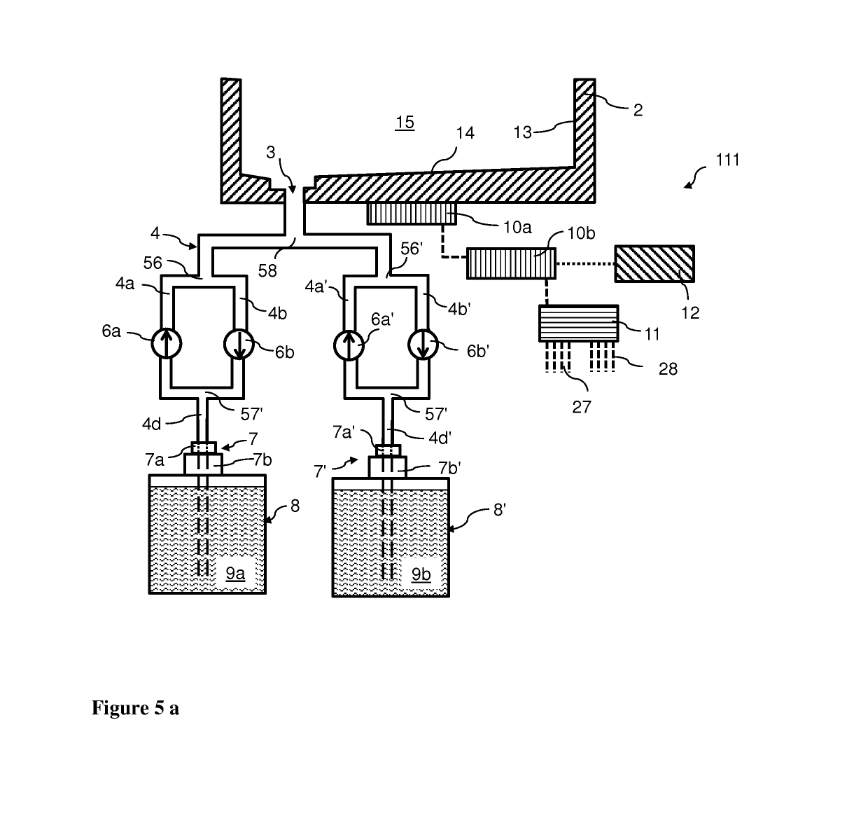

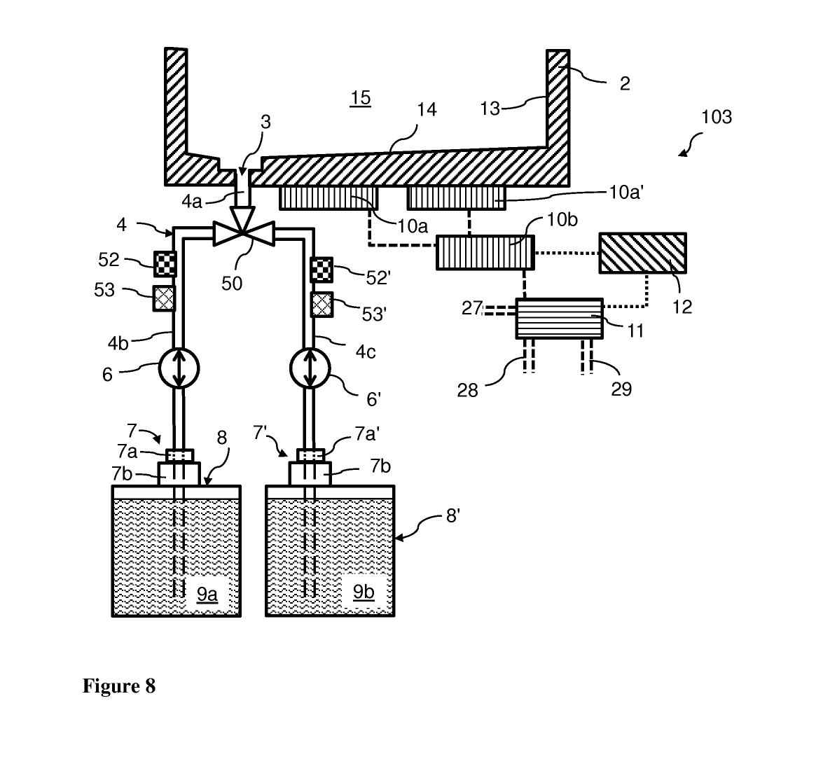

The embodiments shown in FIGS. 5 to 8 differ from the previously described embodiments in that there are either two or more separate cartridges 8, 8′ (FIGS. 5, 8) or that there is one cartridge 80 comprising two or more non-communicating compartments 81, 82 within the single cartridge (FIGS. 6 and 7). In all these embodiments, different liquids 9a and 9b may be used, which may thus be either provided in two different cartridges 8, 8′ or in two separate compartments 81, 82 of a single cartridge. The two cartridges/compartments may comprise the same or different liquid compositions. For example, there may be a first liquid and a second liquid. In an embodiment, the first liquid 9a is a cleaning liquid, which comprises components that are suitable for ultrasonic cleaning, for example, while the second liquid 9b is a rinsing liquid, comprising ingredients suitable for rinsing the object to be cleaning, for facilitating drying and/or for providing perfume on the object after cleaning, for example. Exemplary compositions of said first and second liquids are disclosed elsewhere in this specification.

Turning now specifically to FIG. 5, the cleaning device 111 shown comprises thus two separate liquid channelling systems 4, 4′, each connecting, respectively, one of the cartridges 8, 8′ to one of the two outlet/inlet openings 3, 3′ provided in the cleaning tank 2. Each of the two liquid channelling systems 4, 4′ is constructed as the single liquid channelling system 4 shown in FIG. 4. In general, the components comprised in the second liquid channelling system 4′ may be the same as those of the first liquid channelling system 4. In FIG. 5, the components of the first and second liquid channelling systems have the same reference numerals, but those of the second system 4′ are distinguished in FIG. 5 by the prime sign (′) added at the end.

Reference numerals 27 and 28 indicate the presence of cables connecting the controller 11 to the pumps and valves of the device. Accordingly, the controller controls the action and operation of these valves and pumps and thus controls the functioning and operation of the device.

In FIG. 5, there are two connection assemblies 7, 7′, one for each of the two cartridges 8, 8′. Accordingly, the distal extremity 4d of the first liquid channelling system is connected to a first connector 7a, adapted to connect the first liquid channelling system to a first cartridge connector 7b, so that connectors 7a and 7b form a first connection assembly 7.

“Distal”, for the purpose of this specification, means away (distal) from or with respect the cleaning tank 2, and “proximal” means closer to the cleaning tank. Accordingly, tube section 4a is proximal, and tubes 4b and 4c are intermediate.

Regarding the second liquid channelling system, the same as said above applies accordingly: The distal extremity 4d′ of the second liquid channelling system is connected to a second connector 7a′, adapted to connect the second liquid channelling system 4′ to a second cartridge connector 7b′, so that connectors 7a′ and 7b′ form a second connection assembly 7′.

As becomes apparent, two first and second liquid channelling systems 4, 4′ could be operated completely independently one from the other, for example pumping their respective liquid 9a and 9b simultaneously into and/or out of the cleaning tank. Preferably, however, the two cartridges 8, 8′ connected to the first and second liquid channelling systems, respectively, contain liquids that have a different composition and thus preferably fulfil a different function. As a consequence, the device is preferably programmed and/or arranged to pump liquid compositions 9a and 9b sequentially in and out of the tank 2. More specifically, liquid 9a is preferably a cleaning liquid, comprising, for example, one or more detergents (more details on components of the liquids 9a and 9b are given elsewhere in this specification). Once glasses are placed into an empty tank, and preferably the lid of the device being closed, the controller activates the pump 6a and valves 50 and 51 such that liquid 9a is pumped into the tank from cartridge 8. After cleaning the device using ultrasound, as described elsewhere in this specification, the cleaning liquid 9a is pumped back into corresponding cartridge 8, using this time pump 6b, with valves 50 and 51 being set to the appropriately position. When the cleaning tank is emptied from liquid 9a with the cleaned glasses in it, the second liquid channelling system 4′ is preferably activated. The second cartridge 8′ preferably comprises a rinsing liquid, which may be an aqueous solution comprising an alcohol and which facilitates evaporation of the rinsing liquid 9b from the surfaces of the glasses, once the second liquid 9b being pumped back into its second cartridge 8′. This part of the operating protocol may be referred to as a rinsing step, which is thus preferably conducted after the cleaning step. The rinsing step has the main purpose of removing residual cleaning liquid 9a from the glasses. In some embodiments, this may be important, because some of the cleaning components (detergents etc), may be irritating and/or unhealthy and should thus not remain on the surface of the glasses. As with the cleaning step, the composition comprising the rinsing liquid 9b is pumped back into the second cartridge. During the rinsing step, there is preferably no ultrasonic treatment, so that during the rinsing step the glasses are exposed to the rinsing liquid for a time period, and is then pumped back into the cartridge.

In embodiments and/or process steps of the invention where there is no ultrasonic treatment, the device of the invention may be equipped with means for stirring the liquid in the tanks. Such means may include, for example, one or more pumps, screws, (e.g. magnetic) stir bars, just to mention a few. The liquid in the tank may be stirred in the cleaning steps in case there is no ultrasonic treatment and/or generator, and/or during the rinsing step, for example in embodiments where there is an ultrasonic unit/generator but there is no ultrasonic treatment during the rinsing step.

During the rinsing step, the rinsing liquid 9b is kept in the cleaning tank 2 for a period determined period, the “rinsing period”, which preferably lasts from 1 second to 5 minutes, preferably 5 seconds to 3 minutes, more preferably 10 seconds to 2 minutes, and most preferably for 15 seconds to 1 minute. In accordance with the above mentioned, the liquid in the cleaning tank during rinsing may be stirred but is preferably not stirred in addition to the stirring caused by pumping the rinsing liquid into the tank.

The embodiment shown in FIG. 5a is very similar to the one of FIG. 5, with the main difference being that separate valves 50, 50′, 51 and 51′ are absent. Furthermore, there is only one outlet 3 instead of two outlets connected to the liquid channelling system 4. In the device of FIG. 5a, the valves are part of the pumps 6a, 6b, 6a′, 6b′. In particular, the pumps are selected so that, when switched off or when not pumping, the respective duct 4b, 4c, 4b′, 4c′, with which a given pump is connected, is closed. Accordingly, only one of the four pumps 6a-6b′ operates (pumps liquid) at a given time. For example, if pump 6a′ pumps liquid from cartridge 8′ into the cleaning tank, all other pumps 6a, 6b, 6b′ are switched off or are programmed not to pump any liquid. In this case, the non-operating pumps 6a, 6b, 6b′ close the respective ducts 4b, 4c, and 4c′ and thus function as valves. In this particular case, the liquid 9b is pumped from cartridge 8′ via connector 7′ through ducts 4d′ and 4d′ and via junction 58 through duct 4a into the cleaning tank 2.

As the valves are integrated into the pumps in the embodiment shown in FIG. 5a, the device 111 comprises a plurality of duct connections 56, 46′, 57, 57′, at which respective ducts join or branch off, depending on the direction of liquid flow. The duct 4a connects the tank opening 3 to the junction 58, where two tubes branch off, one leading to cartridge 8 and the other to the other cartridge 8′.

The embodiment shown in FIG. 6 is similar to the one shown in FIG. 5 and differs basically from the latter in that a single cartridge 80 comprising two compartments 81, 82, instead of two physically separate cartridges is used. The two separate, first and second liquid channelling systems 4, 4′ are constructed in the same manner as described with respect to FIG. 5. Furthermore, the device 112 shown in FIG. 6 may be operated in the same manner as the one of FIG. 5. Even the first and second connectors 7a and 7a′ may be the same as the corresponding connectors shown in FIG. 5. The connectors 7b and 7b′ of the cartridge allow connection of the first and second liquid channelling systems 4, 4′, respectively, to the first and second compartments 81, 82. As discussed previously, the distal extremities of the tubes 4d and 4d′ are connected to the connectors 7a, 7a′, respectively, thereby allowing access of the liquid channelling systems 4, 4′ to the contents of the respective, first and second compartments 81, 82.

FIGS. 7 and 8 show preferred embodiments of the invention. In FIG. 7, there are two separate liquid channelling systems 4, 4′, each comprising its respective bidirectional pump 6, 6′. Each channelling system has its own inlet/outlet access 3, 3′ to tank 2. Whether or not a single cartridge with two compartments 81, 82 or two separate cartridges (as shown in FIGS. 5 and 8) are used, is not relevant, although a single cartridge system is preferred for practical reasons, reducing the handling associated with connecting and/or disconnecting cartridges, for example during maintenance and/or exchange of a cartridge.

Comparing FIG. 7 with FIG. 6, the skilled person will understand that two unidirectional pumps 5a, 5b, two three-way valves 50, 51 and a branched liquid channelling system comprising tube sections 4a, 4b, 4c, 4d are replaced in a liquid channelling system by a single bidirectional pump 6, a single two-way valve 5 and a single (non-branched) tube and/or channel 4a. The channelling system of FIG. 7 is thus structurally and/or technically simplified by using a bidirectional pump 6, while providing the same functionality. Of course, the same applies to the second liquid channelling system 5′ in FIG. 7, concerning continuous tube 4a′, valve 5′ and bidirectional pump 6′. Overall, the solution shown in FIG. 7 is developed from the one shown in FIG. 1, taking into account that the device of FIG. 7 allows to branch the device to two different cartridges and/or two compartments 81, 82 of a single cartridge 80.

The device 103 shown in FIG. 8 is yet another preferred embodiment of the present invention. This embodiment may be operated with two cartridges 8, 8′ as shown or with a single cartridge comprising two compartments, as shown in FIGS. 6 and 7.

The device 103 comprises a single liquid channelling system 4, with a proximal tube or tube section 4a, connecting the inlet/outlet opening 3 to a multi-way valve 50. From valve 50, two separate tubes 4b and 4c bifurcate. Each tube 4b and 4c comprises an own bidirectional pump, 6, 6′, respectively. Tube 4b is branched via connector 7a to connector 7b of the first cartridge 8, and tube 4c is branched via connector 7a′ to connector 7b′ of the second cartridge 8′.

For cleaning glasses put into the empty tank 2 using device 103, the controller activates pump 6 to pump the cleaning liquid through tube 4b, valve 50 and tube 4a into the cleaning tank 2. Valve 50 was set accordingly by controller 11 to prevent any liquid from passing into tube 4c at this stage. Once the liquid is in tank 2, the controller shuts channel 4a in valve 50, so that the liquid 9a is locked in the tank. The ultrasonic cleaning treatment is conducted as described elsewhere in this specification. After ultrasonic cleaning, valve 50 is set as before, opening a connection and/or communication between tubes 4a and 4b, and pump 6 pumps the cleaning liquid 9a back into cartridge 8. Thereafter, controller 11 switches valve 50 so that channel 4b is now closed at valve 50 and a liquid duct between tubes 4a and 4c is opened. The second bidirectional pump 6′ is now driven so as to pump the rinsing liquid 9b out of the second cartridge 8′ into the cleaning tank. Once the rinsing liquid is in tank 2, valve 50 shuts channel 4a, so that the liquid 9b, now in the tank 2, cannot drain from the latter. Rinsing of the object in the tank 2, cleaned in the previous step, is now conducted as described elsewhere in this specification. The entire cleaning process is terminated after the rinsing liquid 9b is pumped back via tubes 4a and 4c (tube 4b being again closed at valve 50), to the second cartridge 8′.

FIG. 8 further shows pH sensors 52, 52′ and conductivity sensors 53, 53′. In accordance with an embodiment of the invention, the device comprises one or more pH sensors 52. In addition and/or alternatively, the device of the invention comprises one or more conductivity sensors 53. The pH and/or conductivity sensors are preferably associated with and/or on the liquid channelling system. For example, the pH and/or conductivity sensor may be fixed on a duct of the duct system of the device of the invention. Preferably, the sensors are fixed in such a way as to be able to measure pH and/or conductivity of the cleaning and/or rinsing liquid, for example. For example, the sensors are fixed so as to have a component that is in contact with the cleaning and/or rinsing liquid, for example during pumping the liquid into the tank and/or from the tank into cartridge, as shown in FIG. 8. Alternatively or in addition, the sensors may be associated to the tank 2 and may thus sense the conductivity and/or pH of liquid being in the tank. In an embodiment, conductivity and/or pH sensors may be provided in and/or on the cartridges 8, 8′, 80, 180, 180′. For example, the sensors may be adapted to sense pH and/or conductivity of the liquid in the cartridge.

The pH and/or conductivity sensor is/are preferably connected to (or adapted to be connected to) the electric controller 11, for example by electric connections 29. Accordingly, the controller 11 is programmed to receive a signal from any one, several or all sensors 52, 52′, 53, 53′ and to compare the value read with a reference value so as to be able to warrant safety and/or orderly conduct of the process and/or protocol conducted by the device. For example, if certain pH and/or conductivity values are beyond a predetermined, admissible range, the controller 11 may refuse running a cleaning operation.

While pH sensors 52, 52′ and/or conductivity sensors 53, 53′ are shown in FIG. 8, the above said with respect to sensors preferably applies to all embodiments independently. The sensors are thus preferably present in the embodiment described with reference to FIGS. 1-7 and 9-16. The device may comprise both types of sensors, one or more pH sensor and one or more conductivity sensor.

Furthermore it is noted that the device of the invention may comprise no sensor at all or only one type of sensors, for example one or more sensor selected from pH sensors, or one or more conductivity sensors. In some embodiments, the device is equipped with one or more sensors to measure either conductivity or pH. In other embodiments, both are measured.

In embodiments where there are two liquids (for example 9a and 9b), either pH or conductivity or both may be measured for one or both liquids. It is also encompassed that pH is measured with respect to one liquid and conductivity with respect to the other. In FIG. 8, this could mean that only sensors 52 and 53′ or only 53 and 52′ are present, for example.

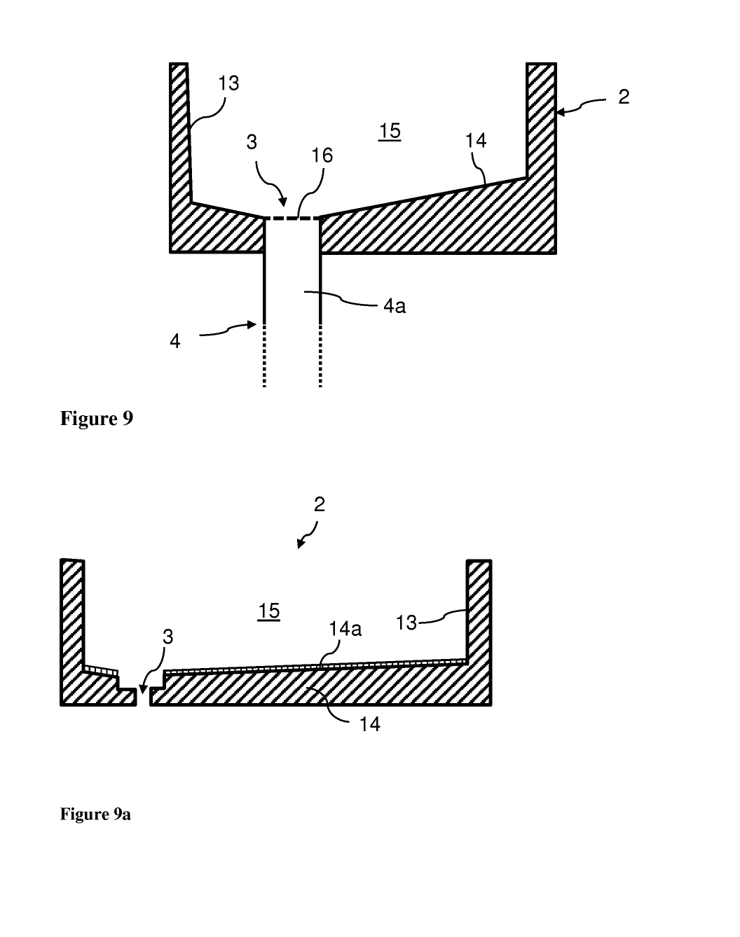

FIG. 9 shows in greater detail an embodiment of the cleaning tank 2 and of the inlet and/or outlet opening 3 of the cleaning tank. As can best be seen in this figure, the inner surfaces and/or inner walls of the cleaning tank are downwardly inclined towards the opening 3. In this way, any liquid present in tank 2 is drained by gravity towards opening 3. In particular, the bottom surface 14 of the cleaning tank is skewed and/or has a curved profile. In this way, the bottom and/or inner walls of tank 2 form positions of various depths within said tank. Preferably, the opening(s) 3, 3a, 3b, 3′ is provided at the deepest position in said tank. In embodiments where there are several openings 3, 3′, 3a, 3b, the openings are preferably close together in the cleaning tank, both or all at the deepest position of the cleaning tank. In FIG. 9, a filter or mesh 16 is shown, which prevents any large particles from passing from the cleaning tank into the liquid channelling system 4. Such a filter is preferably present in any one of the embodiments shown in FIGS. 1 to 8, and with respect to all openings, in case there are several.

FIG. 9a shows an embodiment of a cleaning tank, in which at least part of the bottom surface 14 comprises a protective layer 14a. The protective layer 14a is preferably applied on the bottom surface of the cleaning tank. The protective layer is preferably made from a highly elastic material, such as natural or synthetic rubber, preferably from silicone. The protective layer preferably comprises a material that does not absorb or react to ultrasound waves. The protective layer is such that if an object to be cleaned is placed into the tank, the object is protected from damages that might occur if the object to be cleaned was placed directly on bottom surface 14. During cleaning, the object in the cleaning tank may move due to agitation of the cleaning liquid or due to ultrasound. Thanks to the protective surface, such movement does not result in damage of the object to be cleaned. Accordingly, in an embodiment, the device of the invention lacks an insert 35 that is suspended or otherwise placed in the cleaning tank, as described in particular with respect to FIG. 14. Preferably, the device of the invention can be operated without insert and allows cleaning object that are placed directly on the bottom of the cleaning tank, in particular onto the protective layer 14a. In contrast to the insert 35, the protective layer 14a is permanent and is not a separate piece that is loosely or detachably connected to the device of the invention.

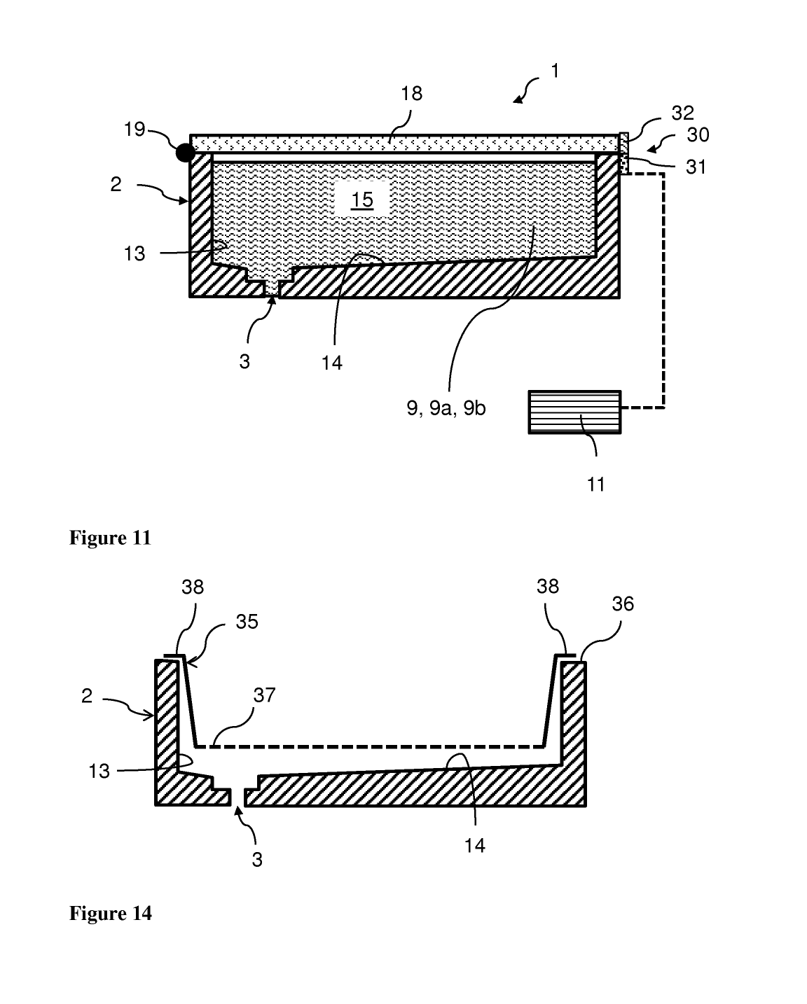

FIGS. 10 and 11 show an embodiment of the device comprising a lid 18. Although not shown in FIGS. 1 to 9, a lid or cover is preferably present in the device of the invention. The lid or cover has been omitted in FIGS. 1 to 9 as it is now separately discussed.

In the embodiment shown in FIGS. 10 and 11, the lid is connected via an articulation 19 to the housing of the device and/or to the cleaning tank 2 itself. The device preferably comprises a closure and/or lock assembly or mechanism 30. The mechanism or assembly 30 is adapted to keep the lid on the tank 2, and/or to keep the tank covered before or during the cleaning and/or rinsing process. In the embodiment shown, the closure mechanism 30 comprises two parts, 31, 32, a tank-part or first part 31 provided on the tank or on the housing of the device, and a lid part or second part 32 provided on the lid. The first and second parts 31, 32 can be locked together and can be released, for example disengaged. For example, the lock mechanism is an electromagnetic lock. Alternatively, a mechanical lock comprising, for example, a lock bar or bolt and a latch, or other types of locks may be used. The lock mechanism is preferably controlled by the controller 11 as schematically shown in FIGS. 10 and 11. The controller 11 closes the lock assembly 30 when an object is placed into the tank 2 and the lid 18 is closed. From that moment, and preferably during the entire cleaning and, if applicable, rinsing process, the controller keeps the mechanism 30 locked, so that a user cannot open the lid during cleaning. This is a safety feature that prevents any spilling of liquid 9′, 9a or 9b that may be present in the tank, as shown in FIG. 11. In a preferred embodiment, the lid and/or the tank comprises one or more gasket or other sealing materials, so that the tank is leakproof and/or waterproof when the lid is closed, and in particular when the lid is locked in the closed position by the locking assembly 30. Preferably, there is no spilling of liquid even in case the device of the invention is shaken and/or falls down, for example from a table onto the floor, with cleaning liquid being present inside the tank 2.

One or more grips and/or handles (not shown) may be provided on the lid and/or tank (in the embodiment discussed below) so as to allow a user to conveniently open the tank.

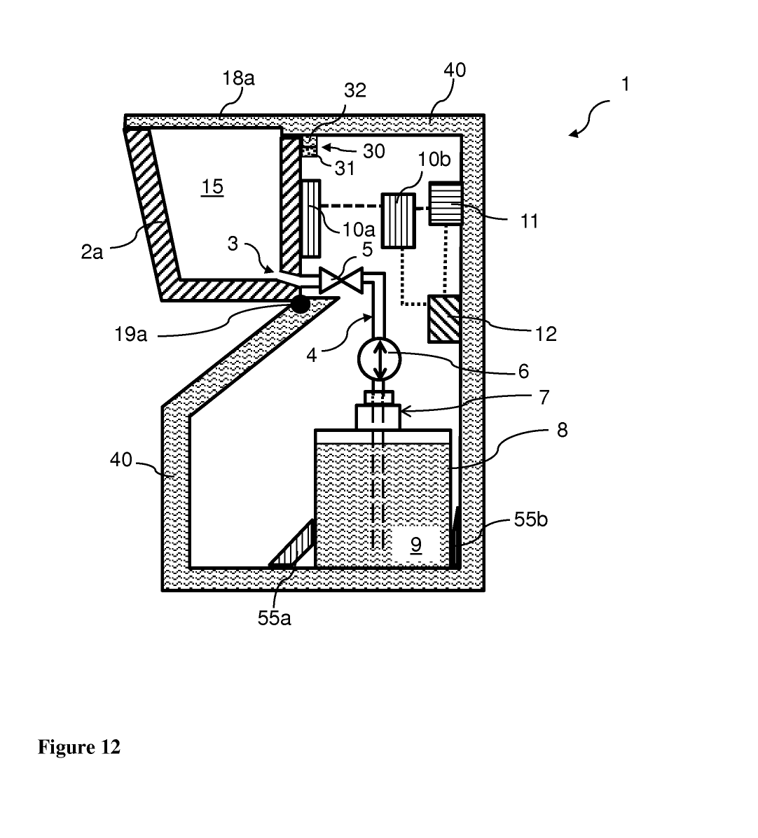

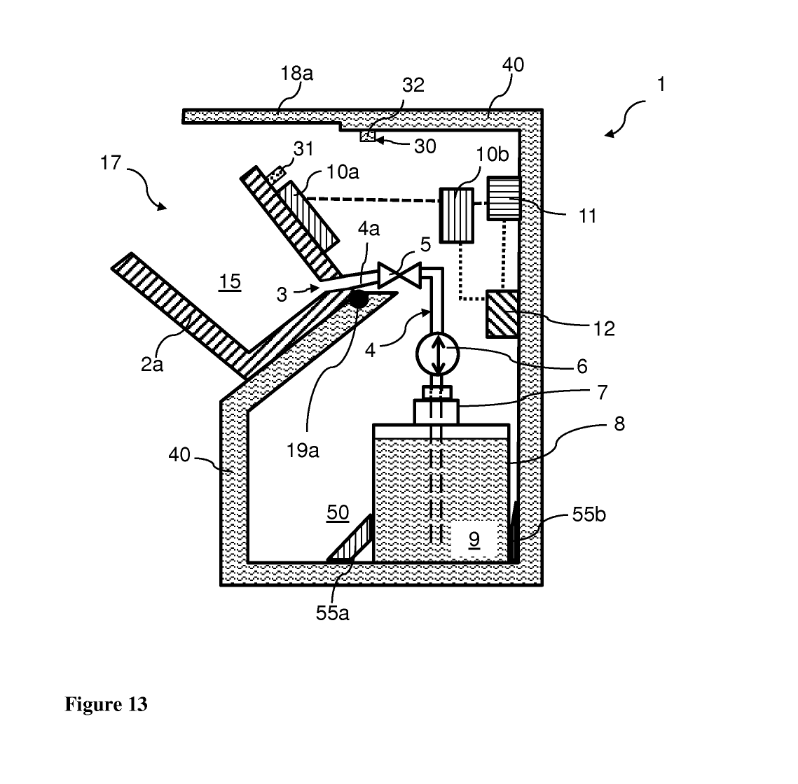

FIGS. 12 and 13 shows an alternative manner of closing the cleaning tank 2 for the purpose of performing the cleaning process. In the embodiment shown in these figures, the lid 18a is part of and/or rigidly connected with the housing 40 of the device. For example, the lid 18a may be formed in one piece with the housing 40. Sealing material may be provided on the lid 18a or on the tank 2a (not shown) for example. The cleaning tank 2a is opened by pivoting at articulation 19a so as to pivot the cleaning tank away from lid 18a. The pivoting movement of the tank, illustrated in FIG. 13, generates the opening 17 of the tank, so that an object to be cleaned can be inserted into the tank. In particular, articulation 19a may pivotally connect the tank 2a to the housing 40. The tank and/or the opening 17 is closed by pivoting back the tank from the position shown in FIG. 13 to the one shown in FIG. 12. As the skilled person will understand, the tube 4a is preferably sufficiently flexible and/or has extra length, so as to be able to follow and compensate the distance that the opening 3 covers when the tank is pivoted. The flexibility and/or sufficient length preferably also applies to the cable by which the ultrasonic transducer 10a is connected to the ultrasonic unit 10b, to the power supply 12 and/or to the controller 11, as may be applicable.

In an embodiment, the device of the invention comprises a housing or casing 40, wherein a cleaning tank 2a, one or more liquid channeling system 4, 4′, one or more pumps 6, 6′, 6a, 6b, one or more valves 5, 5′, 50, 51, one or more ultrasonic unit 10b, ultrasonic transducer 10a, 10a′ and one or more electronic controllers 11 are housed inside said housing or casing. Preferably, the housing or casing 40 provides a lumen or space 50 for harboring said one or more cartridges 8, 8′, 80, 180, 180′.

In an embodiment, said housing and/or casing 40 is configured or adapted to receive said one or more cartridges 8, 8′, 80, 180, 180′, in a space 50 provided inside the casing or housing, so as to hide the view to said one or more cartridges when placed in the housing.

As schematically shown by reference numerals 55a and 55b in FIGS. 12 and 13, the device preferably comprises support structures that are geometrically adapted to receive the cartridges, allowing the cartridges to be positioned in a particular way and preferably stabilized in a specific position and/or orientation as determined by said support structures 55a and 55b.

In an alternative embodiment, the cartridges 8, 8′, 80, 180, 180′ are docked to the outside of the housing and/or casing 40 of the device, so as to remain attached to the outside of the casing, being thus visible to the user. In this embodiment, the device comprises a docking station provided on the outside of the casing, housing or even outside the device. In this embodiment, the docking station preferably comprises the geometrical forms that are complementary to geometrical forms provided on the cartridges and that allow docking and/or connecting the cartridge to the docking station. This embodiment may be similar to the docking of a water tank to an espresso machine. In an embodiment, the device of the invention has one axis of symmetry when viewed from outside. Therefore, a cartridge having one axis of symmetry may be used to allow form-matching docking of the cartridge to the device. This applies, for example, if a cartridge having two compartments is used.

In an embodiment, said tank 2a is movably and/or displaceably connected to the device. In particular, said tank is movably connected to said housing 40, for example to a support or to a casing 40 of said device. A support for movably connecting the tank to the device may be a support frame, for example.

In an embodiment, said tank is pivotally connected to said casing 40 or to a support 40 of said device. Preferably, said tank is capable of conduct a movement having a rotational component of movement.

In an embodiment, said tank 2, 2a, 102 is connected to said housing, casing or support frame 40, 140 so as to be able to accomplish a linear movement, in particular a movement having a linear component of movement, with respect to the device, in particular with respect to said housing, casing or support 40. For example, the tank may be guided in a similar way as a drawer in said casing or housing 40. For example, the device of the invention may comprise a rail structure (not shown), for example a pair of rails, fixed or connected to a support frame 40 of the device, with the tank being guided and/or movably connected on said structure, for example so as to move from a closed to an open position as specified elsewhere. In a preferred embodiment, the tank 2, 2a, 102 is connected so as to be able to accomplish a linear movement and a pivotal movement with respect to the device, in particular with respect to the housing, while staying connected to said housing.

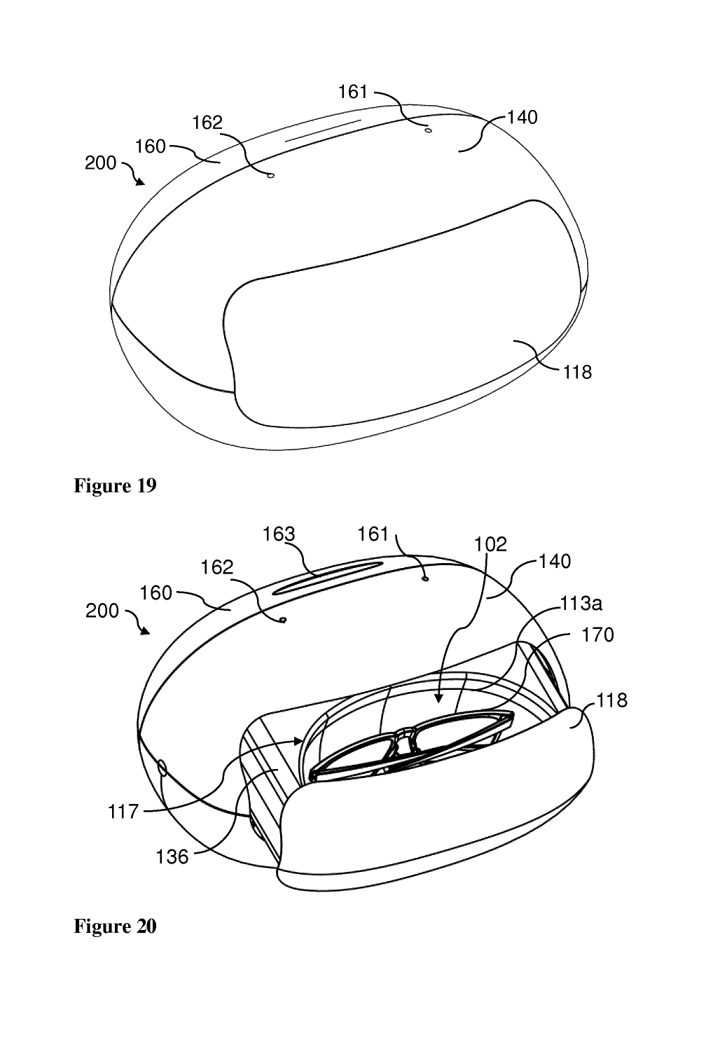

In a preferred embodiment, said tank 2, 2a, 102 is arranged on and/or connected to said housing, casing and/or support 40 to move from a first position (FIG. 12, FIG. 19) to a second position (FIG. 13, FIG. 20) while remaining connected to said device, preferably to the casing and/or support frame of said device, wherein, in said first position, the tank 2, 2a, 102 is closed and a user cannot access to the inside 15 of the tank, and wherein in said second position, an opening 17 to the tank is generated, allowing a user to put an object to be cleaned into said tank or remove a cleaned object from said tank.

The device of the invention preferably comprises motors and/or actuators (not shown) for acting on the tank 2, 2a, 102 so as to move it from the first to the second position, or from the second to the first position, or both. If a movable tank is absent, motors and/or actuators may be used to open and/or close the lid 18. The actuators may be linear actuators, for example.

In an embodiment, the device opens automatically as urged by the action of one or more motors or one or more actuators, but may require manual closing, for example by pushing the tank manually back to the first position, or by closing the lid 18 manually. The device may open by pressing a release button that allows a linear actuator to act on the movable tank 2a and/or lid 18, for example. Alternatively, the device may comprise electronically controlled press buttons, which trigger the activity of an electric motor moving the tank to the second position. In an embodiment, the opening of the tank 2, 2a, 102 is triggered automatically, for example by accomplishment of a cleaning circle.

In the embodiment shown in FIGS. 12 and 13 the housing 40 functions as a casing of the entire device and at the same time as a base, support frame, support platform and/or chassis of the device. Of course, the invention envisages that the support structure, base, etc, which carries, for example the cleaning tank 2, 2a, 102, and/or which receives the one or more cartridges, is a separate piece or unit, and the device further comprises a separate casing, responsible for the overall design of the device when seen by the user. The casing would then preferably be fixed to the support frame. Doors and lids that are opened by a user, for example lid 18 or 18a, or a lid or door provided to access the cartridges inside the device (not shown), may be part of or integrated in the casing of the device of the invention, or may be fixed the housing and/or support frame 40 of the device.

Accordingly, while it is indicated above that the said tank 2a is movably connected to said housing 40, the invention encompasses that the tank is movably connected to a support frame 40 of the device. In this case, at least part of the casing 140 will generally also be fixed to the support frame 145, so that, at least indirectly, said tank 2a, 102 may be movably connected to said casing, for example.

In the embodiment shown in FIG. 13, the one or more ultrasonic transducers 10a remain attached to the cleaning tank 2a. This applies even though the tank 2a is movably connected to a support frame 40 of the device 1. The invention also encompasses that the ultrasonic transducer remains in a fixed position with respect to the housing 40, for example, so that rotation of the tank 2a at articulation 19a results in physical separation of the (fixed) transducer 10a from the articulated tank. The physical contact is re-established when the tank 2a is rotated back to the position where the tank is closed (FIG. 12).

FIG. 14 shows an embodiment on an insert 35 which has not been shown in the cleaning tank of FIGS. 1-12. The insert 35 has the purpose of carrying the object to be cleaned and preventing that the object gets in direct contact with the bottom and/or lateral surfaces of the cleaning tank 2. In particular, the insert prevents that the object to be cleaned is supported directly by the bottom inner surface 14 of the cleaning tank. The insert 35 may be supported and/or held in any suitable way in and/or by the cleaning tank. Preferably, the insert may have a part that will be immersed into the cleaning and/or rinsing liquid during cleaning. The insert may comprise a grid and/or sieve, so that the liquid will easily enter the inner volume of the insert. The insert 35 may comprise one or more holding elements 38, which hold and of fix the insert. For example, the holding elements may prevent the insert itself getting into contact with the inner walls and or bottom walls 13, 14 of the cleaning tank. In an embodiment, the insert 35 comprises a flange 38 that is arranged to lie on the rim 36 of the tank 2, so that the entire insert 35 may be supported on the upper rim 36.

FIGS. 15 and 16 show embodiments of an isolated empty cleaning tank 2 (FIG. 15) and of an isolated cleaning tank 2 filled with cleaning liquid 9 (FIG. 16). These tanks may be used with any one of the embodiments discussed herein comprising one single outlet/inlet opening 3. The tank shown in FIG. 16 comprises a three way valve 50 and fits thus well, for example, with the embodiments shown in FIGS. 3, 4, and 8.

The cleaning tank 2 according to the preferred embodiment shown in FIGS. 15 and 16 is particularly adapted to receiving glasses. Since the device is intended for private use, it is considered advantageous with respect to this invention to keep the volume of the cleaning tank as small as possible, while allowing cleaning of comparatively large glasses. The wall 13 comprises two main side wall parts, a first side wall part 13a and a second side wall part 13b. The first wall part is bent, so as to join the respective ends of the second wall part 13b, which is essentially flat. The flatness of wall part 13b allows the positioning of the one or more ultrasonic transducers 10a on the backside as shown in FIG. 16. Accordingly, the bottom wall 14 has essentially the form of a segment of a circle. Furthermore, the tank is slightly conical, with the horizontal opening on top being larger in surface than the surface of the bottom 14. The inner lumen of the tank 2 is thus adapted to receive a folded pair of glasses comprising a pair of lenses, with temples folded or bent towards the lenses. In particular, the glasses will be put into the cleaning tank with the convex part of the lenses being oriented towards said first side wall part 13a. In the device of the invention, a holding piece 35 is preferably provided so as to assure proper orientation of the glasses when put into the tank 2, 2a, 102.

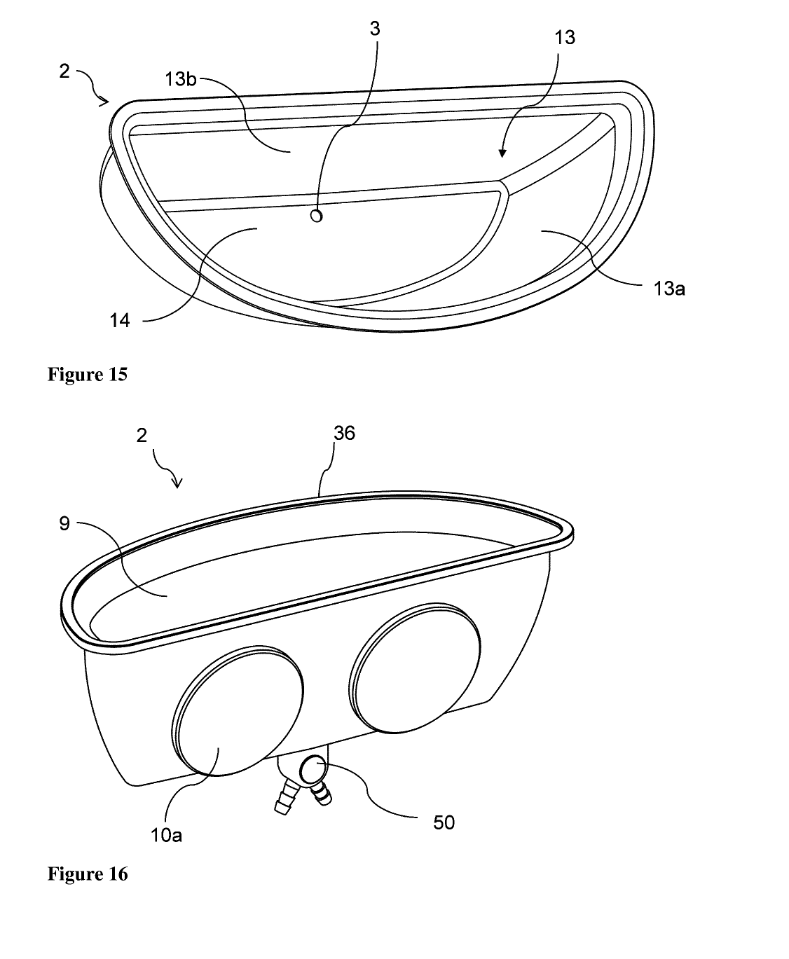

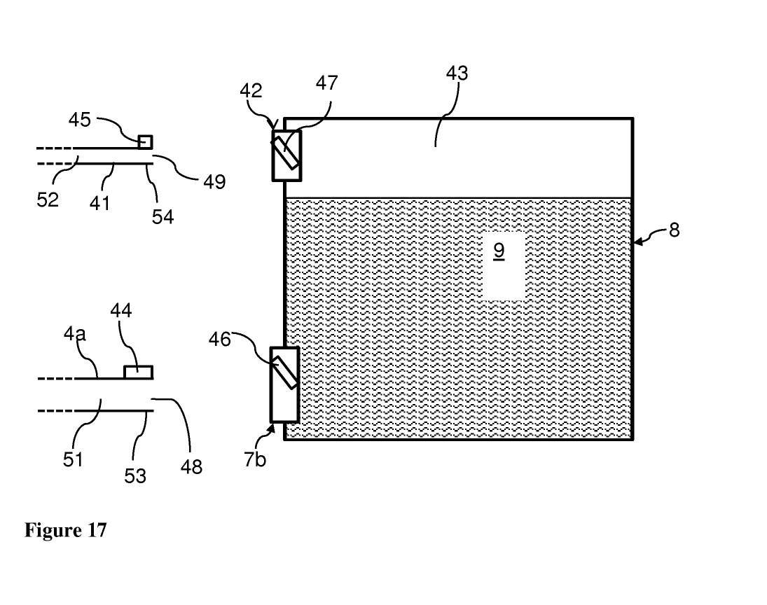

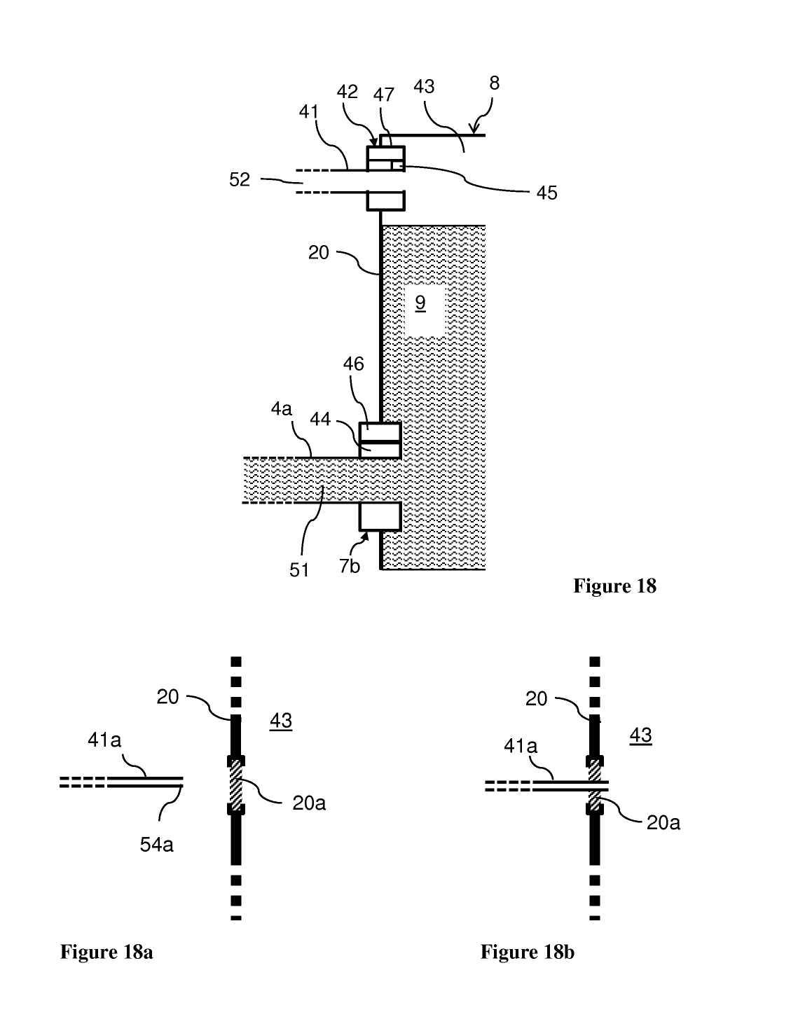

FIGS. 17 and 18 illustrate the branching of a cartridge 8 to the device 1, in particular to the duct system 4 of the device. While some reference numerals in FIGS. 17 and 18 are the same as those of FIG. 1, the embodiments of the following description may be applied generally to all embodiments of FIGS. 1 to 31, in particular to devices using one or two cartridges 8, 8′, 80, 180, 180′ and to cartridges having one or two compartments 81, 82.

The cartridge 8 may be considered as part of the device 1, but as it is a consumable, which needs to be replaced after some use, it can also be considered as a separate unit. The skilled person will note that the device 1 cannot be operated without cartridge, but the cartridge 8 may be commercialized separately. Accordingly, it is necessary to connect a cartridge 8 to the device 1 to be able to clean glasses, and it is also necessary to replace the cartridge 8 when the cleaning liquid (or if the cartridge contains a rinsing liquid, the rinsing liquid) is dirty to the extent that proper cleaning is no longer possible.

The cartridge of the invention is preferably detachably connected to the device of the invention.

As can be seen, the cartridge contains an opening 7b. The opening 7b is preferably provided in the wall 20 of the cartridge 8. The opening 7b is, for example, a valve opening, comprising a valve 46. In the cartridge shown in FIG. 17, the valve 46 of the opening 7b is shown in a closed position, so that the cleaning and/or rinsing liquid 9, as applicable, is retained inside the cartridge 8 and is not spilled.

In an embodiment, the cartridge of the invention comprises one or more valve openings 7b, 42. In an embodiment, the cartridge comprises a valve opening 7b for connection to the liquid channelling system 4, 4′ of the device of the invention. In an embodiment, the cartridge comprises a pressure balancing opening, which is preferably a valve opening.

In FIG. 17, the duct system 4 is only partially shown and is represented by the end 53 of duct 4a. In particular, the duct 4a contains an end 53 with an opening 48, which leads to the inner lumen 51 of the duct 4a and/or duct system 4. As described elsewhere in this specification, the end of a duct may comprise or form a connector 7a (not shown in FIGS. 17-18), which allows to connect the duct system 4 in a water-proof manner to the opening 7b of the cartridge. In the embodiment shown, the open end 53 of duct 4a, represented as the end of a tube, is considered to work as connector 7a as described elsewhere in this specification. In another embodiment, a fixed connection, for example by a releasable click-mechanism, is absent, and the connection of the open end of duct 4a to the valve opening 47 is not rigid. This is possible because the cartridge 8, when branched to duct 4a, may be held in position by mechanical means, for example a structural or supporting components in the housing 40 of the device, or by a lid (not shown), and the same may apply to the end of duct 4a, so that a rigid connection between the duct system 4 and the cartridge 8 is not required for assuring that the connection to opening 7a is not inadvertently disengaged.

The insertion of the duct end 53 with the valve opening 7b results in opening of the valve 46. Reference numeral 46 in FIGS. 17 and 18 may represent the valve of valve opening 7b as a whole or just the structural element that controls the opening of the valve (valve closing structure). Accordingly, when duct end 53 connects to said opening 7b, the valve is opened, for example due to displacement of the valve closure structure 46. Accordingly, in an embodiment, the cartridge 8 is preferably not opened by removal of a lid, for example by removal of a screwed lid, of a sealed lid or the like. On the contrary, the cartridge opening 7b is preferably opened by displacement of a valve structure inside the valve opening 7b. As is usual the case, the valve closing structure 46 is generally urged to a closed-valve position, so that the opening 7b is generally closed. The connection with tube 4a displaces the valve structure 46 so as to open opening 7b. Accordingly, the valve 46 preferably comprises a resilient means (not shown), which urges the valve 46 to a position in which the opening 7b to is water-tightly closed. When opening the cartridge, the end 53 or opening 48 of the duct system 4 acts so as to oppose the force of said resilient means, thereby opening the opening 7b.

As becomes apparent from the above, the opening 7b is preferably not intended to be opened by the user. This is an optional safety feature of the present invention, which makes sure that the user does not get in contact with the liquid contents of the cartridge 8. This implies that the valve 46 is preferably not hand-operated or user-operated. The opening is preferably not achieved (or not intended to be achieved) by a user acting with a tool, such as a screw driver, on the opening 7b. The opening and closing of valve 46 is preferably mechanically controlled, without direct mechanical action of the user on the valve, as would be the case with a tap, for example. Of course, this does not prejudice the use of an inviolability, for example a sticker or seal provided on the opening 7b for indicating that the cartridge has not yet been used. In a preferred embodiment, the cartridge is indeed provided with an inviolability (not shown).

In an embodiment, the open end 53 of the duct system 4 comprises a valve interacting structure 44. The valve interacting structure 44 is structurally adapted and/or formed so as to be able to act on valve closing structure 46. For example, valve interacting structure 44 comprises a geometric form and/or dimensions that are required for it to be able to act on valve closing structure 46. In this regard, the opening 7b of the cartridge 8 preferably comprises a geometric configuration that allows insertion of the duct 4a and in particular of duct end 53 into an access area of the opening 7b (not shown). The duct end 53 and opening 7b are preferably configured as a male-female connection system. Preferably, the male-female connection system 53 (involving structure 44)/7b is configured to warrant correct orientation and direction of the connection.

In FIG. 18, the duct 4a is connected to the cartridge 8 at opening 7b, so that the liquid 9 in the cartridge communicates with the inner lumen 51 of the duct 4a and therefore with the entire duct system 4. FIG. 8 thus shows the connection between the duct system 4 and the cartridge 8 in a state that allows operation of the device. The liquid 9 can now be pumped into the tank 2, 2a, 102 (FIGS. 1, 12,) for cleaning and/or rinsing the object in the tank, as applicable.

In an embodiment, the cartridge 8 of the invention comprises a pressure balance opening 42. The purpose of opening 42 is to avoid substantial under or over-pressure due to the removal of liquid 9, 9a, and pumping back of liquid after cleaning/rinsing. In an embodiment, the pressure balancing opening 42 is a simple hole in the cartridge, which may be created when the cartridge is connected the duct system, for example when the cartridge is placed to or into the housing 40. For example, the device may comprise a piercing structure (41a), which cuts a hole into the cartridge when the latter is positioned for operation with the device. For example, the cartridge 8, 8′, 80, 180, 180′ may comprise a predetermined breaking zone, which is adapted to give rise to an opening when the cartridge is connected to the device of the invention.

In FIG. 17, the pressure balancing opening 42 is a valve opening, which may be similarly configured as the opening 7a for the liquid. Preferably, the device comprises an air duct 41 and/or air valve opening structure 45, which is adapted to engage with opening 42 when the cartridge 8 is connected to the device of the invention. The interaction of the end of air duct 54 with the cartridge opening 42 opens the valve 47. It is noted that a duct system as in the case of duct system 4 is not required. The air duct 41 just needs to allow air escape from or get into the cartridge through opening 42. In an embodiment, the air duct 41 is essentially reduced to the valve interacting structure 45 fixed to the housing of the device, so as to open opening 42 when the cartridge is connected to the device. The air that passes opening 42 may thus enter from the inside of the casing 40 or from the outside of the device. In case an air duct 51 is present, the latter may connect to an opening on the outer surface of the casing 40 of the device. Reference numeral 43 indicates the air that may be present in the cartridge 8. If the cartridge 8 is made of a rigid material, the inner volume of the cartridge remains constant and balancing of air pressure inside the cartridge may be required. In some embodiments, cartridge 8 is made of flexible material, so that cartridge 8 is actually a pouch. In this case, an air pressure balancing valve or opening 42 may be absent, as the inner lumen of the cartridge adapts to the pressure inside the pouch 8.

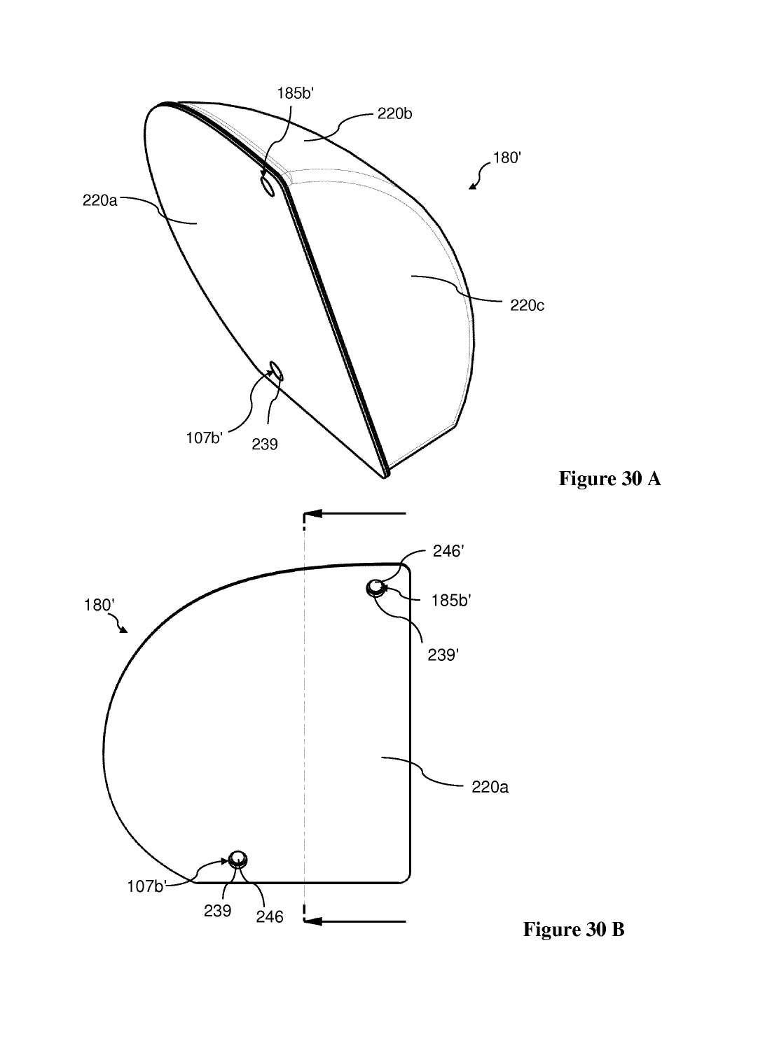

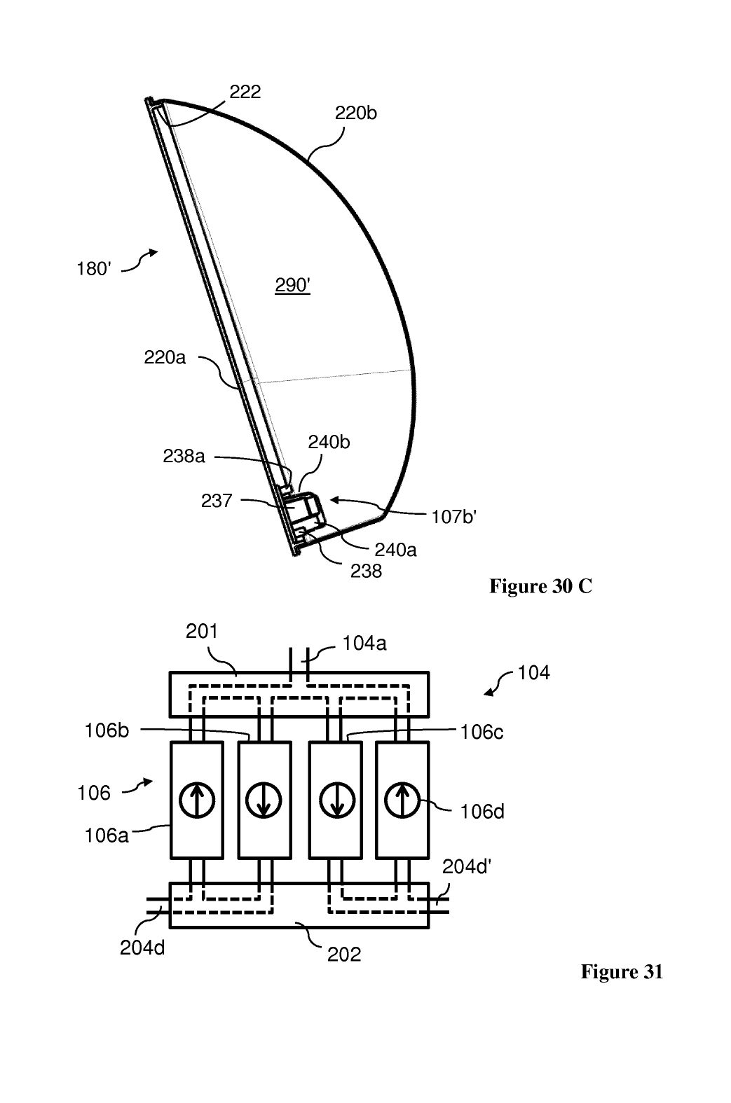

An alternative way of providing a pressure balancing opening in the cartridge of the invention is shown in FIGS. 18a and 18b. These figures show a cross section through part of a cartridge wall 20, roughly corresponding to the position on the top of FIG. 18. The cartridge wall 20 is shown as a thick line, with the dashed lines indication the continuation of the cartridge wall. The cartridge wall 20 comprises a wall section or part 20a, which is preferably made from an elastic, resilient polymer, sch as rubber or silicone, for example. Preferably, the remainder of the wall of the cartridge is rigid, as shown in other embodiments in this specification, such as with respect to FIGS. 30A-30C, for example. However, wall part 20a represents relatively small surface of the cartridge wall, for example from 0.5 to about 25 cm². The material is selected such that it can be pierced by a pointed or spiky object, without being completely broken. When the spiky object is removed, the opening or passage created by the pointed object closes due to the elastic properties of the material from which wall section 20a is made. Accordingly, cartridge wall part 20a functions lake the membrane of a perforable vials for medicaments, which may be pierced by a syringe and which closes automatically once the syringe is removed.

In an embodiment, the cartridge of the invention comprises a pierceable or perforable membrane 20a made from a resilient and elastic material, such as rubber or silicone, for example. Rubber may be natural or synthetic rubber. The perforable membrane is preferably part of the cartridge wall 20a.

The device preferably comprises a tube 41a, which is thin enough to perforate the membrane 20a. Preferably, tube 41a comprises a tube end 54a which is adapted to perforate wall section 20a. In an embodiment, the tube 41a is not a freestanding element of the device of the invention, but is associated to a displacement mechanism (not shown), which urges the tube 41a through the wall section 20a only once a cartridge is placed in the device invention. In the device shown in FIGS. 19-30, the connectors 185 and 185′ can be replaced by a piercing tube 41a. Preferably, the piercing tube 41a is housed within the device, for example within an opening of wall 146 (FIG. 146), and is moved when the cover 160 is closed and/or when a cartridge is branched to the device. For example, the tube 41a could be moved by an electric motor or could be moved by a mechanical arrangement associated with the lid of the cartridges (for example lid 160 in FIG. 30), such that the closure of the lid results in emergence of the perforating tube 41a and perforation of the wall section 20a of the cartridge branched to the device. As the pressure balancing opening 42 in FIGS. 17 and 18, the perforable membrane 20a achieves a closure of the cartridge when the latter is removed from the device. In this manner, liquid spillage from the cartridge is avoided.

In an embodiment, the device of the invention comprises structural elements, for example reference numerals 55a and 55b in FIGS. 12 and 13, guiding the cartridge 8 in a particular orientation and position when being connected to the device, for example when placed inside casing 40. The thee-dimensional shape of the cartridge is preferably adapted to the lumen in the casing adapted to receive the cartridge. In this manner, the cartridge can only be connected in a particular manner and/or orientation to the housing and to the device in general. This represents a safety feature, which makes sure that a user can only connect the cartridge 8 in the correct manner to the housing 40. In particular, the housing comprises geometrical arrangements 55a and 55b that match the geometrical form of the cartridge. This applies to the embodiments where there is one cartridge comprising two compartments as well as devices adapted to receive two separate cartridges comprising different liquids (FIGS. 5 and 8). In the latter case, cartridges 8, 8′ may not have an identical shape.

In an embodiment, the cartridges 8, 8′, 80, 180, 180′ are not rotationally symmetric. In an embodiment of the invention, the cartridge of the invention has two (2) or less axis of symmetry, preferably one (1) or less axis of symmetry. In an embodiment where there is one cartridge 80 comprising two separate compartments 81, 82, the cartridge preferably comprises one axis of symmetry.

In a preferred embodiment, the cartridge of the invention lacks any axis of symmetry. Preferably, if there are two cartridges, the two cartridges are distinguished in that they are not mirror symmetric. In a preferred embodiment, the two cartridges 8, 8′ to be received in or by the same device of the invention are enantiomorphs, that is, chiral objects. Thanks to this feature, each of the two cartridges 8, 8′ can only be connected at one position in the housing, given that the housing comprises guiding structures or forms 55a and 55b that are complementary to at least part of the respective cartridge, so as to allow proper positioning of the cartridges while avoiding confusion with respect to the liquids 9a and 9b in the cartridges. The device thus comprises guiding structures geometrically arranged to receive those parts of the cartridge or cartridges that account for their low level of symmetry (e.g. 1 axis) or lack of symmetry and/or their property as enantiomorphs, as applicable.

In another embodiment, the cartridges 8, 8′ are provided with optical codes, for example color codes, which allow a user to correctly connect the two cartridges to the device, as the corresponding codes are provided on the device and/or inside the device, for example in a cartridge receiving structure in the housing.

Preferably, the opening 53 and/or connector 7a are rigidly provided in the device, for example inside the housing 40. Correct placement of the respective cartridge 8 inside the housing and/or correct connection to the device 1 then results in an automatic connection of the duct system 4 to the cartridge. The user is thus not required to branch the cartridge to the duct system by manually connecting the connectors 7a and 7b. On the contrary, the device preferably comprises guiding structures 55a and 55b provided on or inside the device, preferably inside the casing, which guiding structures are complementary to the geometrical form or design of the cartridge, so that the latter is automatically branched via its opening 7b to the liquid channelling system 4.

In an embodiment, the housing or casing 40 comprises one or more selected from a lid, door and/or lock through which a user can access said cartridges 8, 8′, 80, 180, 180′ receivable by the housing for adding or removing said cartridges from said housing, thereby connecting and/or disconnecting, respectively, said one or more cartridge 8, 8′, 80, 180, 180′ from said liquid channeling system 4, 4′. For example, the housing comprises a casing comprising a lid for the cartridge (not shown), the lid comprising a geometrical configuration allowing the cartridge to be placed on an inner surface of the lid via geometrically matching and/or complementary forms, and wherein, upon closing said lid, the cartridge is guided so as to be connected to the liquid channeling system 4, 4′. In the case of two cartridges, two lids may be provided, or a single lid with a geometrical configuration for receiving both cartridges.

The invention also provides liquids and/or liquid compositions for use with the device of the invention, and liquid compositions for use in cleaning methods, in particular ultrasonic cleaning.

In an embodiment, the composition comprises water, one or more alkaline compounds or salts, such as NaOH and/or NH₃, and surfactants. This applies preferably to the cleaning composition 9, 9a, for example in cases when there are two different compositions 9a and 9b. The cleaning composition may but need not comprise an organic solvent, such as isopropanol, for example. Water is preferably used as the main or only solvent of the cleaning composition. The organic solvent may be used in the cleaning composition for dissolving organic components that may be present. The alkaline product is preferably used for saponification of fats and other lipids and allows their suspension in water. Surfactants reduce surface tension and solubilises lipids, in particular fats and oils.

The rinsing composition 9b preferably also comprises water and further comprises an alcohol or another volatile, nonhazardous solvent, for example isopropanol, for aiding the drying of the glasses after rinsing.

In an embodiment, one or more of the liquid compositions 9, 9a and 9b comprises perfumes. Preferably, the rinsing composition 9b comprises perfumes, for example for improving the perception of the cleaning and/or for hedonic purposes in general.

In an embodiment, one or more of the liquid compositions 9, 9a and 9b comprises a colouring agent. Colouring is preferably used to identification of the product and/distinguishing from another product.

More details on the cleaning and/or rinsing liquids are given elsewhere in this specification.

Preferably, each cartridge 8, 8′, 80, 180, 180′ comprises a product identification code and/or or chip. The device of the invention preferably comprises a reader and/or sensor (not shown), which may be connected to the controller 11. In an embodiment, the invention encompasses a method in which the controller 11 of the device counts the number of cleaning cycles performed with a given cartridge. The controller preferably compares the number of cycles performed with a given cartridge with a reference value and, if the reference value is reached, may refuse to perform any further cleaning cycle. Alternatively, or in addition, the device may comprise output devices, and the controller may inform the user via the output device that the cartridge has to be changed. The output device may comprise a source of light, for example an LED, which is switched on once the recommended or maximum number of cleaning cycles (reference value) is attained with a given cartridge. The reference value may be in the range of 10 to 70 cleaning cycles, for example 20 to 60, more preferably 30 to 50 cleaning cycles.

FIGS. 19 to 27 show another embodiment of the device 200 of the present invention. In some of these figures, some parts may be removed for improving the visibility of features as discussed herein below.

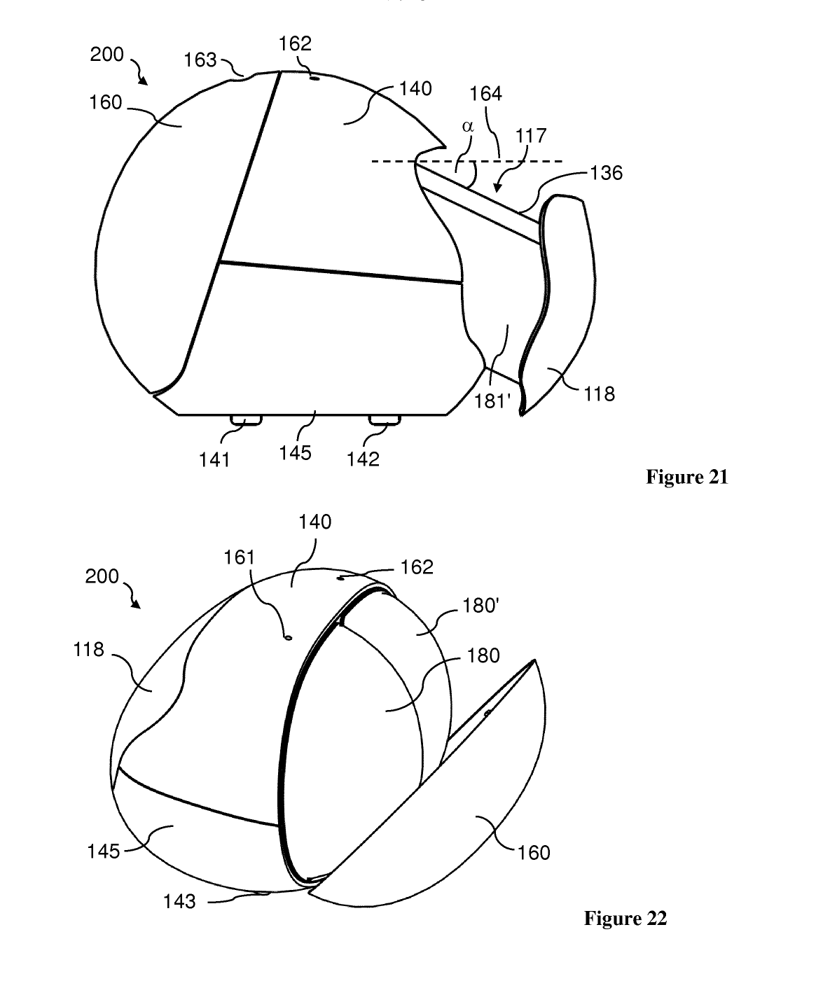

For the purpose of this specification, indications with respect to the position or orientation of structural elements of the device 200, such as left, right, bottom, top, and so forth, are defined from the perspective of a user standing in front of the device and intending to use the device for putting an object to be cleaned into the cleaning tank 102. Accordingly, FIGS. 19 and 20 are front and left lateral perspective views of the device 200, the cleaning tank cover 118 being thus in front of the device and the lid for the cartridges 160 is behind the device. FIG. 21 is a view to the left side of the device 200.

The device 200 comprises a housing 140, and a lid or cover 118 arranged to allow access to the cleaning tank when opened. As cover 118 is closed, the cleaning tank cannot be seen in FIG. 19. The device comprises a second lid or door 160, which, when opened, gives access to the cartridges containing the cleaning and/or rinsing liquids. The housing comprises indicators 161, 162, which serve to indicate status of the device or other information to the user of the device. The indicators 161, 162 may be LEDs. The indicators 161, 162 may also indicate information regarding the status of the cleaning and/or rinsing liquids, in particular if the liquids can still be used or if one or both of them have to be changed.

In FIGS. 20 and 21, the door or lid 118 has been opened completely, and the observer can see the cleaning tank 102 and the object 170 that is placed in the cleaning tank 120, here a pair of glasses 170. An inner side wall 113a of the cleaning tank can also be seen in FIG. 20. Furthermore, it can be seen that the door 160 comprises, at its top, a recess 163, which can serve as a grip allowing the user to conveniently open the lid 160. Of course, other structures for gripping or manipulating the lid 160, such as a handle and so forth, may be provided instead of recess 163. As the skilled person will understand, the opening of the cleaning tank 102 involves a displacement of the latter. In the embodiment shown, the cleaning tank thus conducts a movement having a linear component of movement, similar to a drawer, in order to give access to the inside of the cleaning tank via its top opening 117.

The opening 117 of the cleaning tank 102 preferably has the same curved shape as visible in FIG. 15, which opening defines the entire form of the cleaning tank 102, similar to a half-moon or a segment of a circle. The shape or lumen of the cleaning tank is thus particularly adapted to receiving a pair of glasses with the temples being folded, so that the front side of the lenses faces the curved inner side wall 113a (the first side wall part as described with respect to FIG. 15) of the cleaning tank and the folded temples face the substantially even inner side wall (second side wall part) of the cleaning tank 102. The even side wall is preferably oriented towards the door 118 (not visible in FIG. 20).

In the lateral side view of FIG. 21, one can see that the upper border or edge 136 of the cleaning tank 102 is flat, but, with the lid or cover 118 of the cleaning tank being completely opened, is skewed by angle α with respect to horizontal 164. Preferably, the angle cc of the upper edge 136 of the cleaning tank with respect to horizontal 164 is about 0-60°, preferably 5°-40°, more preferably 15°-35°, even more preferably 20°-30°, and most preferably 23°-28°. In an embodiment, the angle α of the upper rim 136 with respect to horizontal is larger than 0° as would be the case in a typical, linearly moving drawer. Without wishing to be bound by theory, the difference with respect to horizontal renders it more convenient to the user to access the inside of the cleaning tank, that is, to place an object 170 to be cleaned inside the tank and to remove a cleaned object from the tank, for example. This convenience is due to the fact that generally, the device 200 will be placed on a piece of furniture, such as a table or chest of drawers and that the user will thus look in a downward direction when facing the device 200. By choosing angle α as defined herein, the surface of the opening 117 and/or cleaning tank 102 may preferably be oriented substantially perpendicularly with respect to the direction of the look of the user.

In FIG. 21, it can further be seen that the cleaning tank 102 is laterally covered by a cover 181′. Cover 181′ moves with the tank 102 when opening and closing the device and is thus rigidly connected to the cleaning tank 102. As will become apparent from the figures discussed further below, lateral cover 181′ covers at least part of a cleaning tank subassembly 121, which is connected to a mechanism that guides the movement of the cleaning tank 102.

The device of the invention preferably comprises a plurality of foots, preferably for foots, of which left lateral foots 141, 142 are visible in FIG. 21.

In FIG. 22, the cleaning tank 102 is closed, moved inside the device with the cover 118 being in the closed position, but the lid 160 of the cartridges is opened, so than cartridges 180, 180′ can be seen. Also a third foot 143 can be seen in the right, rear perspective view of FIG. 22.

In a preferred embodiment, the door 118 of the cleaning tank is on the front side of the device of the invention, facing the user placing an object in the cleaning tank 102, and the lid 160 for the cartridges is provided on the rear side of the device.

In the embodiment shown, lid 160 is fixed pivotally to the housing 140 of the device, so that the lid 160 is opened and closed by pivoting the lid 160 with respect to the housing. Preferably, the lid 160 is pivotably connected at the bottom of the rear part of the device 200.

As can be seen in FIG. 22, the device of the invention is preferably adapted to receive two cartridges 180, 180′. The two cartridges 180, 180′ preferably contain different liquids, as described elsewhere in this specification, in particular with respect to cartridges 8, 8′ and 80. Preferably, the cartridges 180, 180′ comprise a cleaning liquid 9a and a rinsing or drying liquid 9b.

The skilled person will notice that the device of the invention has an overall rounded shape, lacking any sharp edges or angles. When seen from lateral (FIG. 22), the device is nearly circular or elliptical (when closed), with the exception of the bottom 145, which is flat so that the device can be put on a flat surface. The rounded shape also applies to the cartridges, as can be seen in FIGS. 30A-C. The rounded shape is adapted to optimize the space occupied by the device and is particularly useful to provide cartridges having a large volume while minimizing the occurrence of non-used space.

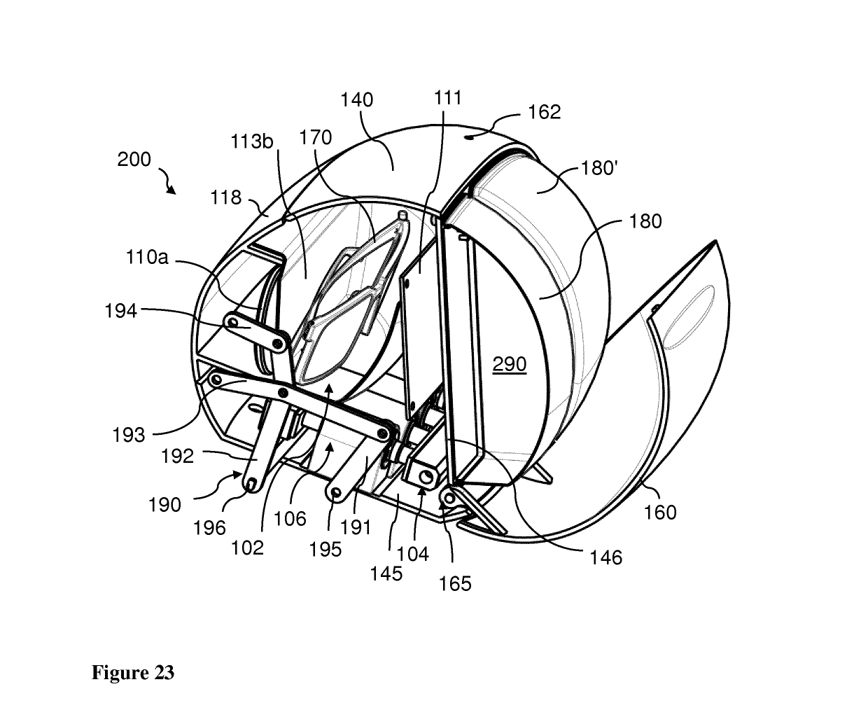

FIG. 23 is a perspective view combined with a vertical section perpendicular to the left-to-right horizontal axis of the device. The section goes vertically across the housing 140, the cartridge 180′, the cleaning tank 102 and the cover 160, but leaves intact the right lateral part of the displacement mechanism 190, which is arranged to manage or guide the displacement of the cleaning tank 102 when opening or closing the device 200. In FIG. 23, an ultrasonic transducer 110a can be seen, which is positioned on the outer surface of the cleaning tank 102, in particular on the even side wall 113b, as has also been illustrated with respect to transducer 10a shown in FIG. 16.

The displacement mechanism 190 preferably connects the cleaning tank 102 with the housing 140, or with a support or chassis provided in the housing. In an embodiment, the displacement mechanism 190 is connected to the housing 140, or to a support or chassis provided in the device of the invention.

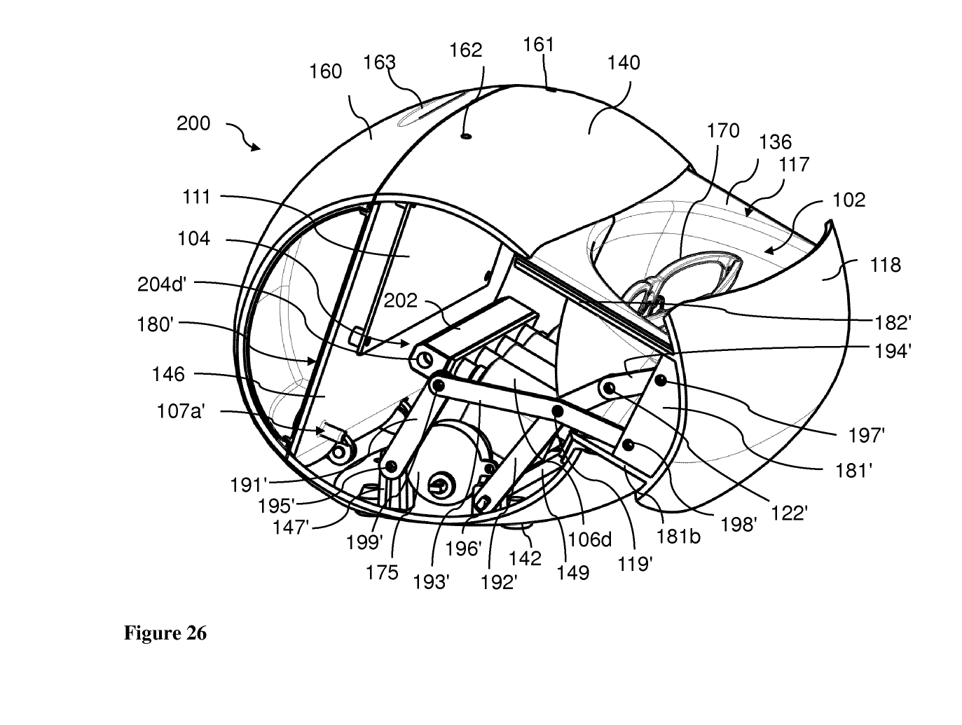

In the embodiment shown, the displacement mechanism 190 comprises a plurality of levers or link bars 191-194 (and 191′-194′ shown in FIG. 26), which, together, determine the movement of the cleaning tank 102 when opening and closing the device, and in particular cover or lid 118. In the embodiment shown, the displacement mechanism 190 comprises a plurality of levers or pivoting bars 191-194 connecting the housing to the cleaning tank 102 and thereby guiding the displacement of the latter. The displacement mechanism comprises an analoguous mechanism of levers on the left side of the cleaning tank, as can be seen in FIG. 26.

The pump block 106 comprises four pumps 106a-106d aligned next to each other, in accordance with the general scheme shown in FIG. 31. Furthermore, the presence of the liquid channeling system can be seen at reference numeral 104. Some of the tubes and ducts required for making up the entire liquid channeling system 104 are omitted, but are similar as schematically shown in FIGS. 5 and 5a (FIG. 31).

FIG. 23 further shows the pivotal articulation 165 by which the lid 160 is connected to the housing or support 140 of the device, in particular to the bottom plate or support 145 of the housing 140. The wall 146 is part of the support or housing 140 of the device and separates the space for the cartridges (on the right side in FIG. 23) from the inside of the housing 140, which is not accessible by the user. The inside of the device (no reference numeral) is thus delimited by the housing 140, the wall 145 and, when the device is opened, by the cover 181 visible in FIG. 21. The cover 181 has been omitted in FIG. 23 so as to allow better view to the right part of the displacement mechanism 190. In the completely assembled device, the cover 181 prevents access by the user to the displacement mechanism 190 and thus constitutes a safety feature, preventing, for example, that an outside object or the finger of the user gets in contact with the displacement mechanism 190.

The plate 111 is fixed on the inside side of wall 145 of the device. Electronics, such as one or more selected from the controller 11 (FIGS. 1-8, 10 and 11), ultrasonic unit 10b, and power supply 12 are preferably fixed on plate 111.

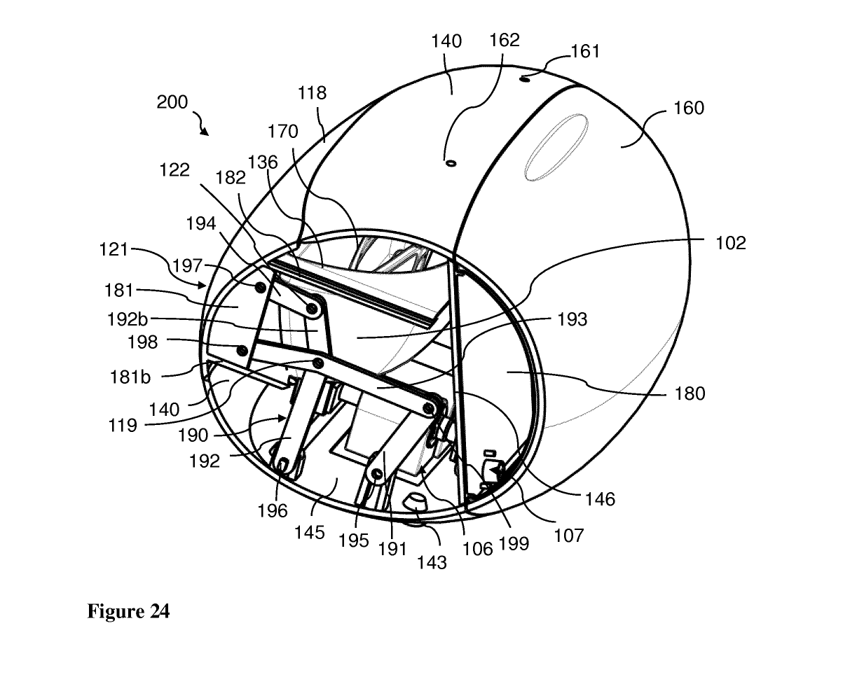

FIGS. 24 to 26 illustrate the displacement movement of the cleaning tank 102 when the device of the invention is opened and closed. In FIG. 24, the vertical section is taken in parallel to the section in FIG. 23 but slightly displaced to the right, so that the pivotal connections 197 and 197 of the displacement mechanism 190 to the cleaning tank 102, and in particular to the lateral cover 181 of the cleaning tank can be seen. It is noted that part of the lateral cover 181 is removed, so that it can better be seen how the displacement mechanism 190 is connected to the cover 181. The mechanism 190 for guiding and moving the cleaning tank 102 in a desired, determined way so as to open and close the tank can now be explained on the basis of the right side shown in FIGS. 23-24, it being noted that the structural elements shown in FIG. 26 may need to be consulted for full understanding.

In the embodiment shown, the device of the invention has a central, vertical plane of symmetry, the device thus being bilateral, having two, left and right, substantially identical sides. This also applies substantially to many structural elements in the inside of the device, as can be seen from FIG. 26, which will be discussed separately further below.

The mechanism 190 comprises two levers 191 and 192 that are connected to the housing 140 or to the support or chassis 145 of the device. The support 145 can be part of the housing 140, as shown in FIG. 24, or can be a separate support to which the housing is fixed. The two levers are a rear lever 191 and a front lever 192 and are pivotally connected at one of their extremities to the housing or support 145 at rear and front articulations 195 and 196. At their other extremities, rear and front levers 191 and 192 are connected to the same connecting lever 193, which extends substantially horizontally from the rear to the front ends of the inside of the device. In particular, levers 191 and 192 are pivotally connected to connecting lever 193 at rear and front articulations 199 and 119. The skilled person will understand that articulations 195, 196, 199, 119 can be regarded as the edges of a quadrilateral in which all articulations move simultaneously. The upper or connecting lever 193 will move from the rear to the front upon pivoting of the entire mechanism 190. At its front extremity, connecting lever 193 extends beyond articulation 119 and is pivotally connected on the cover 181 of the cleaning tank 102 at articulation 198. The cover 181 is actually connected in a rigid or fixed manner to the door 118 and to the cleaning tank 102 and is part of a displaceable cleaning tank assembly 121, encompassing pieces 118, 181, 181′, 182 and 102. Front lever 192 extends upwardly beyond front articulation 119 at extension 192b, which is connected via an auxiliary lever 194 to lateral cover plate 181 to the cleaning tank assembly 121.

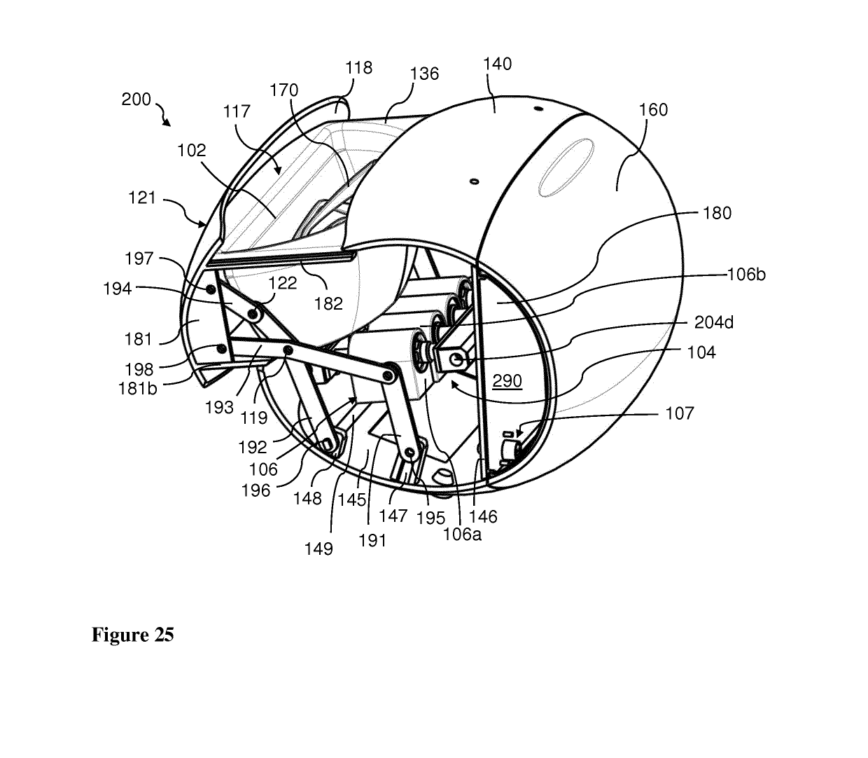

In FIG. 25, the device is shown with the cleaning tank assembly 121 being opened so as to give access via the opening 117 to the inside of the cleaning tank 102. When opened, a user can remove the glasses 170 from the tank, or can put glasses into the tank in case the latter is empty. As one can understand, the entire lever assembly 190, encompassing levers or bars 191, 192, 193, 194 has pivoted towards to front side of the device (to the left in FIG. 25) compared to the closed device shown in FIG. 24. The pivoting of the lever assembly 190 results in a movement of the cleaning tank assembly 121, so that the cleaning tank opening 117 becomes uncovered. In particular, the cleaning tank assembly 121 moves out of the housing 140, similar to a drawer.

As the skilled person will understand, the movement that is executed by the cleaning tank 102 when passing from the positions shown in FIG. 24 to that in FIG. 25 comprises a linear as well as a rotational component of movement.

In particular, when present in the housing 140 (the device being closed), the opening 117 of the cleaning tank is in horizontally oriented. In other words, the upper rim 136, which defines the opening 117, is substantially horizontal. Of course, this applies if the device 200 as a whole is placed in a horizontal position. The horizontal position is advantageous during operation of the device, when liquid is present in the cleaning tank 102. In contrast, when opened as shown in FIGS. 2520 and 21, the opening 117 or rim 136 is at an angle α with respect to horizontal, as shown in FIG. 21. The change of the angle of rim 136 or opening 117 from horizontal to angle α as described elsewhere in this specification is the result of the rotational movement component (see also FIG. 12). The movement of the cleaning tank assembly 121 and thus the angle α of rim 136 in the open position is determined by the orientation and length of the levers 191-194 and the positions of articulations 195, 196, 199, 119, 122, 197, and 198.

It is in particular noted that the pivotal connection 197 of the front lever 192 to the cleaning tank assembly 121 (via auxiliary articulation and lever 122 and 194, respectively) articulation is above the pivotal connection 198 of the connecting lever 193. While lever 193 performs a substantially linear movement from the rear to front, as mainly determined by the quadrilateral of articulations 195, 196, 119, 199, front lever 192, via auxiliary lever 194 will cause a skewing of the upper part of the cleaning tank 102 with respect to the lower part, so as substantially contribute to the rotational movement component of the cleaning tank.

In the embodiment shown, the cleaning tank assembly 121 comprises, besides the cleaning tank 102 and the front lid 118 several additional structural elements. In particular, the tank is rigidly connected or fixed to lateral bar 182. The bar 182, in turn, is rigidly connected to the lid 118. In particular, the bar 182 extends laterally below the upper rim 136 of the cleaning tank and thus supports or carries the cleaning tank. The tank is actually suspended at two, left and right lateral bars 182 and 182′, the latter being visible in FIG. 26. The cleaning tank assembly further comprises lateral cover 181, which has the purpose of hiding the displacement mechanism 190. In the embodiment shown, the lateral cover 181 also carries the pivotal connections 198 and 197 of the displacement mechanism 190 and thus serves as connection of the cleaning tank assembly 121 to the remainder of device 200, in particular to the support 145 or housing 140. The cleaning tank assembly also comprises a bottom cover 181b, which covers the bottom of the cleaning tank (when open). Covers 181, 181′ and 181b are arranged such than the inside of the device 200, where the pump block 106 and electronics are housed, is not accessible by a user.

In FIG. 25 it can be seen that the entire pump block 106 moves with the cleaning tank. In the embodiment shown, the pump block is thus rigidly connected to the cleaning tank assembly 121. In another embodiment, the pump block 106 is rigidly connected to the housing 140 or support 145 of the device and does not move with the tank assembly 121.

As further shown in FIG. 25, pump block 6 comprises four pumps, in accordance with the embodiments shown in FIGS. 5, 5a, 6 and 31. Pump 106a is best visible in FIG. 25. Instead of four unilateral pumps, it is possible to use bidirectional pumps. In this case, the number of pumps can be reduced from four to two, as shown in FIGS. 7 and 8.

The ducts connecting the pumps to the connectors 107a, 107a′ of the cartridges 180 and 180′, respectively, are not shown in detail, as this can be deduced from FIGS. 1-9. Reference numeral 104 generally designates the liquid channeling system. The duct 204d of the liquid channeling system, which duct is shown as an opening in FIG. 25, leads via a tube (not shown) to the connection assembly 107 of cartridge 108, both visible in FIG. 25, and described in more detail with reference to FIG. 31.

FIG. 26 is a view similar to that of FIG. 25, but showing the left side of the device. Several structural elements are a left side duplicate of corresponding structures on the right side shown in FIG. 25 and do not need a detailed description any more. For example, the structural elements making up the left side of the displacement mechanism 190 are indicated with a prime sign (′) behind the reference numeral, while using otherwise the same reference numeral as in FIGS. 23-25. The skilled person will understand that the left and right side parts of the displacement mechanism 190 (191-194, 147-148, 195-196, 119, 199, 198, 122, 197; and, 191′-194′, 147′, 148′, 195′, 196′, 119′, 199′, 198′, 122′, 197′, 192′), are arranged on the left and right lateral sides of the cleaning tank 102, so as to guide together and in a synchronous manner the movement of the tank when opening and closing the device. It is noted that the left and right parts of the displacement mechanism 190 are connected to each other so as to move simultaneously and synchronously. In particular, the left and right parts of the displacement mechanism 190 are fixed to the left and right lateral covers 181′ and 181 of the cleaning tank, respectively, and to the left and right, rear and front pivot supports 147, 147′; 148, 148′, respectively, on the chassis or bottom part 145 of housing 140 of the device. As the right lateral cover 181 and the right lateral bar 182, the left lateral cover 181′ and left lateral bar 182′ are part of the cleaning tank assembly 121. Transversal axle 149 (also visible in FIG. 25), is rigidly connected, at its lateral extremities, to front lateral bars 192 and 192′ respectively. In this manner, bars 192 and 192′ are mechanically coupled so as to behave as a single piece, that is, pivot together around the axis defined by axle 149.

In FIG. 26, the electric motor 175 can be seen, which is arranged so as to open and close the cleaning tank 102. The motor 175 acts on the displacement mechanism 190, for example on bar 191′, so as to move the latter and thereby move the entire displacement mechanism 190. As the skilled person understands, the motor 175 could act upon any piece of the displacement mechanism, such as on the transversal axle 149, front lateral lever 192′, connecting lever 193′. Preferably, the motor 175 acts upon one or more elements of the displacement mechanism that conducts a uniform movement. For example, the motor 175 acts on one pivoting levers 191′ and/or 192′, or on the rotating axle 149. The device may comprise one, two, or more electric motors 175 for opening and/or closing the cleaning tank 102, in particular for displacing the cleaning tank 102 in order to open and close it.

In FIG. 26, the left cartridge 180′ is shown vertically sectioned, showing the walls of the latter as a segment of a circle. The left and right cartridges 180′ and 180 fitting with device 200 will be described in more detail further below. The part of the liquid channeling system that communicates with cartridge 180′ is indicated with reference numeral 204d′, which points at the lumen of said liquid channeling system. The lumen is connected with connector 107a′. The tubes or ducts for connecting lumen 204d′ with connector 107a′ are not shown in FIG. 26, but are analogous to the scheme of FIG. 5b. Pump 106d is one of the four unidirectional pumps of the pump block 106 of the device shown in FIG. 26. The liquid channeling system 104 of the embodiment shown in FIGS. 19-28 is shown in some more detail in FIG. 31.

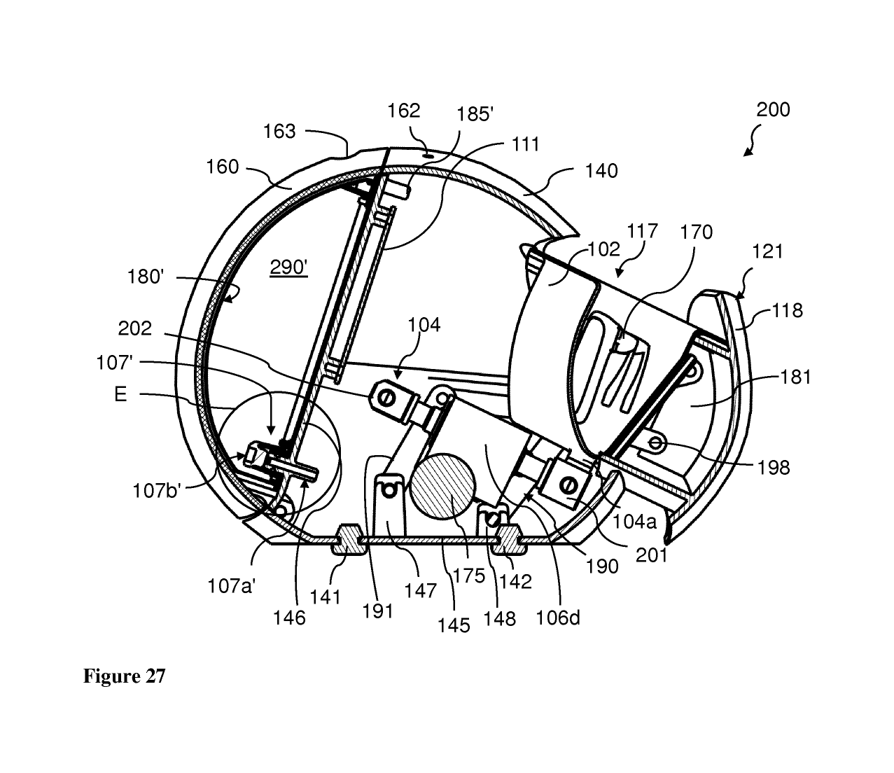

FIG. 27 shows a view to a lateral, vertical section across the left-to-right, transversal direction of the device 200. In FIG. 27, the same structural elements have the same reference numerals as in FIGS. 19-26. The vertical section crosses the device at the level of the feet 141 and 142, which also cuts the connection assembly 107′ to the left cartridge 180′.

It is noted that the left lateral part of the displacement mechanism 190 is not visible, as this part would be laterally further left compared to the connection assembly 107′. However, some elements of the right part of the displacement mechanism 190, in as far as they are not covered by the cleaning tank assembly and the pump block 106, are visible. In FIG. 27. the tube or duct block 201 can be seen. The duct block 201 contains several junctions as described in more detail with respect to FIG. 31. The ducts in duct block 201 contain a connection to tube 104a, which leads into the cleaning tank, and four connections or openings to the tubes leading to the four unidirectional pumps 106a-d of pump block 106.

In FIG. 27, the ultrasonic transducers and electronic equipment are not shown, but plate 111 on which the electronic equipment are preferably mounted is visible.

FIG. 27 shows a vertical section of the connection assembly 107′. At connection assembly 107′, the left or first cartridge 180′ is branched to the liquid channeling system 104, which leads, via specific pumps in the pump block, to the cleaning tank 102. Although not visible in FIG. 27, the right or second cartridge 180 is branched in an analogous manner via liquid channeling system 104 to tank 102. It is noted that the liquid channeling system 104 is branched in the junction piece 201 (FIG. 31), which separates liquid transport between the two cartridges 180 and 180′.

The connection assembly 107′ comprises a part 107a′ that is rigidly fixed to the device. This part comprises a tube and is further adapted to interact with a part 107b′ rigidly connected to the cartridge 180′. As mentioned previously, the cartridge 180′ is placed in the device in an area that can be open closed by lid 160 and can be removed from the device, thereby disconnecting interacting parts 107a′ and 107b′. When connected as shown in FIG. 27, the connection assembly 107′ is open, and liquid is free to pass through the assembly 107′, thereby allowing fluid to be transported to the cleaning tank in accordance with the invention. When disconnected, Part 107b′ on the cartridge 180′ is adapted to close the opening contained in the cartridge at 107b′, following the general principle described above with respect to FIGS. 17-18.

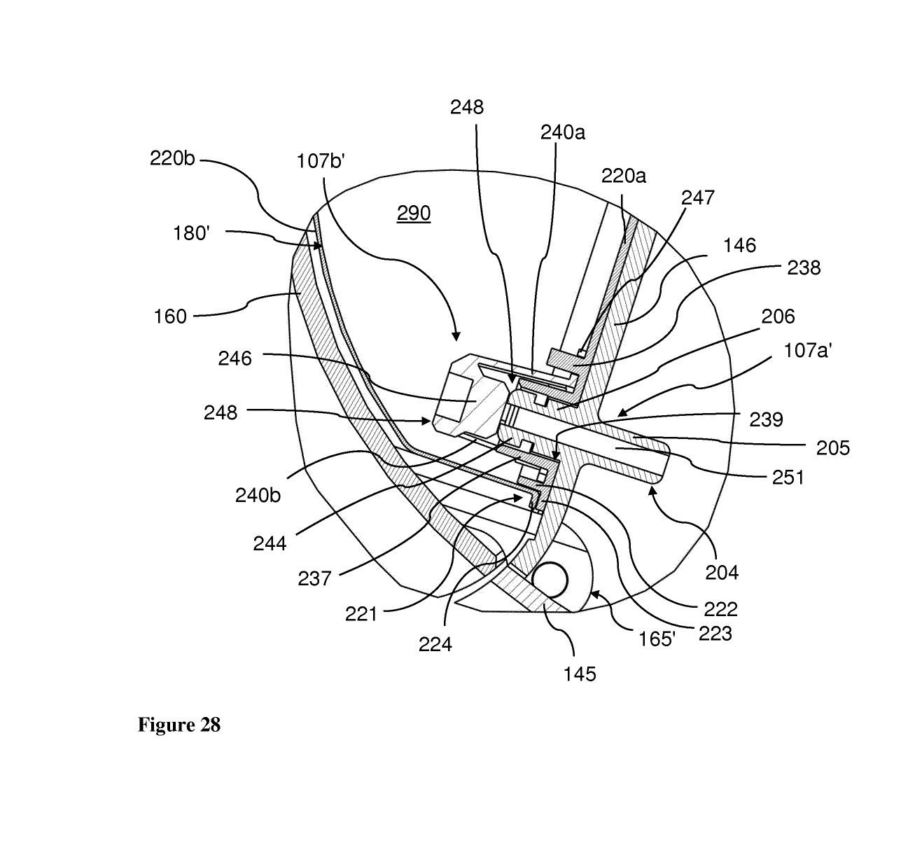

FIG. 28 is an enlargement of the extract substantially covered by the circle E in FIG. 27, showing the connection assembly 107′ in greater detail.

It is noted in general that the cartridge of the invention preferably comprises a valve closure. In accordance with the invention, any suitable valve closure can be used. The valve closure is preferably adapted so as to open a liquid channel when the cartridge is placed at a determined position in the device. Preferably, by placing the cartridge in the device, the valve closure is preferably opened, so as to allow communication of the inside of the cartridge with the liquid channeling system of the device. For example, the valve closure can conveniently be a check valve, for example a ball chek valve. Such a valve can be held in a closed position under the action of a spring pushing a ball towards a valve opening. A ball check valve can be opened by providing a structure in the connection assembly, in particular in said connector of the device, that pushes the ball, against the spring force, away from the opening, so as to open the valve. Other types of check valves can be sued, for example selected from swing check valves, tilting disk check valves, diaphragm check valves, stop check valves, lift check valves, in-line check valves and duck-bill check valves.

In accordance with the invention, the valve is preferably permanently opened as soon as the cartridge is connected to the liquid channeling system of the device.

In the embodiment shown in FIG. 28, the connection assembly 107′ comprises a connector 107a′, which is part of the device of the invention, and an opening mechanism 107b′, which comprises the valve and which is part of the cartridge 180′. The connector 107a′ basically comprises or consists of a tube 204. At one end 205, the tube 204 is branched to the liquid channeling system (not shown, but see FIGS. 1-8 and 17-18 for general description). At the other end 206, tube 204 comprises a valve interacting structure 244, which acts as male part of the connection assembly 107′. In the embodiment shown, the tube 204 is arranged in wall element 146 of the device. In particular, tube 204 extends on both sides away from wall 146, in a direction that is substantially perpendicular to the surface of the wall 146. Tube 204 comprises thus two tubular parts, 205 and 206, on each side of the wall 146. The part 206 of tube 204 is adapted to interact with the cartridge and thus forms part of the connection assembly 107′. Tube part 205 is adapted to be connected to the liquid channeling system and can also be regarded as being part of the latter.

The cartridge 180′ comprises a wall element 220a, which is in contact with or which faces wall element 146 of the device 200, allowing the connector 107a′ and the opening 107b′ to come together. The opening mechanism 107b′ preferably operates as a female part of the connection assembly 107′ in that it comprises an opening 239 leading into a tubular part 237, into which the valve interacting structure 244 is inserted.

The tubular part 237 is provided on a hole or opening 239 in the wall 220a of the cartridge. In FIG. 28, tube 206 is inserted in the opening 239 in the wall 220a and surrounded by the tubular part 237 of the cartridge wall. In this regard, parts 244/204 and 239, respectively, function as male and female parts of the connection assembly 107′, by which the cartridge is connected to the device. Tube 206 fits into tube 237 provided in the cartridge wall.

The valve closure is formed by an obstructing plug 246, which is arranged to close the opening 239 from the inside 290′ of the cartridge. The plug 246 is urged towards the tube 237 leading to opening 239 by a plurality of biasing elements 240a, 240b. In the embodiment shown, the biasing elements 240a, 240b are elastic strips. In the embodiment shown, the biasing elements are positioned or attached by a retainer or guiding structure 238, which keeps the plurality of biasing elements at a determined position. The guiding structure 238 may be rigidly connected to the wall part 220a of the cartridge, for example may be formed in one piece with the wall part 220a. The retainer structure 238 fixes one end of the biasing elements 240a, 240b, while the other end is connected to the plug 246. Preferably, the retainer structure is provided next to the opening 239 on the wall part 220a. In this manner, the flexible strips 240a, 240b urge the plug 246 in a direction towards opening 239.

When the cartridge 180′ is removed from the device 200 and thus disconnected from connector 107a′, plug 246 is urged into the tube 237 and thus obstructs or closes opening 239. On the other hand, with the cartridge 180′ being placed in the device and branched to connector 107a′, the male part 206 and in particular the valve interacting structure 244, pushes the plug out of tubular opening 237 and allows exchange of liquids through the channel 251 of the connector 107a′.

It is noted that, in the embodiment shown, the plurality of biasing elements 240a, 240b and the plug 246 are made from the same material and preferably in one piece 248, for example from an integrally molded, elastic polymer, such as natural or synthetic rubber or from a silicone (silicon-based polymeric materials). In particular, the valve closing structure is a valve piece 248, which is positioned on positioning structure 238 on the inside of cartridge wall 220a. Although this is not well visible in FIG. 28, the valve piece 248 comprises a washer-like, annular flange 247, comprising holes through which retainer pins 238 are guided. Preferably, there is a plurality of positioning pins like pin 238 (not visible in FIG. 28) aligned with holes on the circumference of flange 247. The elastic biasing elements 240a, 240b are connected at the respective position on the flange 247. The closure or valve piece 248 may thus be integrally molded with a plurality of elastic strips and the flange 247. The valve piece 248 may comprise two, three, four or more biasing elements 240a.

FIGS. 30 A to 30 C show the cartridge 180′ removed from the device 200 of FIGS. 19-27. In accordance, the cartridges comprising cleaning, rinsing and/or drying liquid, such as cartridges 180, 180′, are detachably and/or removably associated with the device of the invention. The cartridges are thus a consumable, which is intended to be replaced when the liquid contained in the respective cartridge is no longer useful. The cartridges can preferably be removed from the device without using any specific tool or instrument, for example without a screwdriver, wrench or the like. Preferably, the cartridges can be removed manually, that is by hand. The cartridges may, for example, be connected to the device by way of a clip mechanism (not shown), but this is not mandatory. In the device shown in FIGS. 19-28, the cartridges are guided to the correct position in the device by way of matching and/or complementary forms. Accordingly, the outer shape of the cartridge matches the space harboring the cartridges inside the device, as can be seen from FIGS. 22 and 23, for example. Each cartridge 180, 180′ can only be placed in one possible way into the device 200.

Preferably, the cartridges of the invention are asymmetric or have one or less planes of symmetry. If there are two cartridges, in accordance with preferred embodiments, the two cartridges are preferably a pair of enantiomorphs. In other words, cartridge 180 is the mirror image of cartridge 180′. In this way, the two cartridges are substantially identical with respect to dimensions and volume, but cannot be misplaced in the device 200. Preferably, the cartridges of the invention are placed inside the housing of the device 200. In this regard, the wall 146 and the lid 160 shown in FIGS. 19-27 are part of the housing of the device. Lid 160 and cover 118 are displaceable parts of the housing, allowing for opening and closing, while shell 140 and support 145 are the non-displaceable parts 140 and 145 of the housing of the device 200.

The housing of the device of the invention thus preferably comprises form-matching structures adapted to match the form of the cartridges, in order to allow correct positioning of the cartridge with respect to the device or inside the device, thereby branching the contents of the cartridge with the liquid channeling system of the device.

As can be seen in FIGS. 30A-30C, the cartridge comprises a wall, which defines the volume of and/or a compartment the cartridge. In the embodiment shown, the cartridge wall comprises several different wall parts 220a, 220b, 220c, which are put together so as to form a closed recipient, with the only openings being the two valve openings 107b′ and 185b′. The cartridge 180′ comprises a flat or even wall portion 220a. The valve openings 107b′ and 185b′ may conveniently be provided in the even wall portion 220a, but this is not mandatory. The cartridge 180′ comprises a curved wall part 220b and a second even wall part 220c. Wall parts 220b and 220c are preferably formed in one piece, for example by injection molding. Wall part 220a may also be formed by injection molding. The piece 220b/220c is preferably sealed on piece 220a so as to define the volume 290′ of the cartridge.

As has been described with respect to FIGS. 17-18, the cartridge of the invention preferably comprises at least two openings, 107b′ and 185b′.

At least one, but preferably both openings of the compartment of the cartridge are valve openings 107b′ and 185b′.

The first valve opening 107b′ is adapted to connect the cartridge to the liquid channeling system of the device and thereby to enable liquid transport to the cleaning tank and back to the cartridge. The second opening 185b′ is preferably an air valve opening/pressure balancing opening. It makes sure that the pressure inside the cartridge is constant or is maintained within a range so that damages to the cartridge are avoided. The pressure balancing opening 185′ has also the purpose of allowing smooth emptying and refilling, avoiding the occurrence of pressure or low pressure which could hamper the functioning of the pumps, in particular which could act against the liquid flow as controlled by the pumps. In accordance with the invention, it is preferred that the tank filling and emptying takes place rapidly, at high liquid transport rate, which as such could favour the occurrence of above or below barometric pressure.

In an alternative embodiment, the pressure balancing or air 185b′ opening lacks a valve. For example, the pressure balancing opening 185b′ could actually be a simple hole. For example, the opening 185b′ could be formed once the cartridge is branched to the device, for example by a protruding structure of the device, for example a sharpened or spiky protruding structure. In this case, the cartridge of the invention may comprise a pre-perforated region or rupture area, which is easily ruptured when the cartridge is connected to the device.

The pressure balancing or air passage opening 185b′ makes it possible to use a single opening 107b′ for liquid passage, in particular for emptying the cartridge and refilling it with the same liquid after a cleaning, rinsing and/or drying cycle, as applicable. In particular, thanks to the opening 185b′, the cartridge as such can seal its liquid content in a substantially a water proof manner. In an embodiment of the cartridge of the invention, the pressure balancing opening is omitted. For example, in case collapsible cartridges, such as pouches, the pressure balancing opening can be avoided.

Preferably, the cartridges of the invention are not collapsible, that is, comprise rigid wall parts that define a constant volume or inner lumen 290.

Openings 107b′ and 185b′ are preferably elongated from each other on the cartridge. Pressure balancing opening 185b′ is preferably situated to an upper extremity or top of the cartridge when placed at its operating position in or onto the device of the invention. On the other hand, the liquid opening 107b′ is preferably placed at a lower extremity or towards the bottom of the cartridge when placed at its operating position in or onto the device of the invention. In this manner, a maximum amount of liquid contained in the cartridge can be pumped into the cleaning tank, in particular if a tube 4e as shown in FIG. 1 is absent, for example.

In FIG. 30 B, the plugs 246 and 246′ of the respective valves, as described with respect to FIG. 28, can be seen through the openings 239 and 239′ in the cartridge wall 220a. The plugs 246 and 246′ will thus be displaced when the cartridge is connected to the device of the invention.

As can best be seen in FIGS. 28 and 30C, the wall part 220a comprises a projecting rim 222, which is preferably circumferential. The piece 220b/220c is placed onto wall part 220a so as to match onto the external surface of said rim and obtain a seal 221 (FIG. 28). Wall parts 220b, 220c end in a circumferential flange 224, which comes to rest on circumferential flange 223 on the periphery of wall part 220a. The piece formed from wall parts 220b and 220c is thus formed to fit onto or around the rim 222 formed on wall part 220a. A sealing mass or glue may be provided on the zone where piece 220b/c and piece 220a are in contact, for example.

Instead of air passage openings 185b′ comprising a valve, the cartridge may comprise perforable openings such as described elsewhere in this specification. For example, air passage openings 185b′ of the cartridges shown in FIGS. 30A-30C may be replaced by a perforable membrane or walls ection 20a as described with respect to FIGS. 18a and 18b. In this case, the connectors 185, 185′ of the device are preferably replaced by a structure that is adapted to create an air passage in the cartridge wall, such as a spiky tube.

In accordance with a preferred embodiment, the cartridge of the invention lacks any opening that is intended to be opened by hand and/or by the user, or which can otherwise give access to the contents of the cartridge by the user.

In an embodiment, the cartridge lacks an open and/or non-closable opening.

Preferably, valve opening 107b′ and pressure balancing opening 185b′ are the only openings leading to the inner lumen 290′ of the cartridge 180′. Preferably, the risk that a user getting in contact with the liquid contents of the cartridge is reduced by omitting any opening that can be manually (by hand) actuated by the user. Of course, a user could still insert an oblong object into opening 239 so as to cause leakage of the liquid contents of the cartridge. However, this would be unsafe handling and thus be contrary to the operating manual of the device.

In accordance with a preferred embodiment, the cartridges of the invention are made from a plastic material. In particular, the wall parts 220a-220c of the cartridge preferably comprise or are made from plastic.

As indicated above, cartridge 180 is a mirror image of cartridge 180′ and can be connected to the device, preferably in the housing of the device, at its appropriate position, as shown in FIGS. 22 and 23. As the skilled person can understand, cartridges 180 and 180′ could also be provide in the form of a single unit having two separate compartments, as if cartridges 180 and 180′ were rigidly connected in the position shown in FIG. 22. Embodiments with single cartridges having separate compartments have been described with respect to FIGS. 6 and 7.

Cartridges 180 and 180′ have preferably the same volume as disclosed elsewhere in this specification.

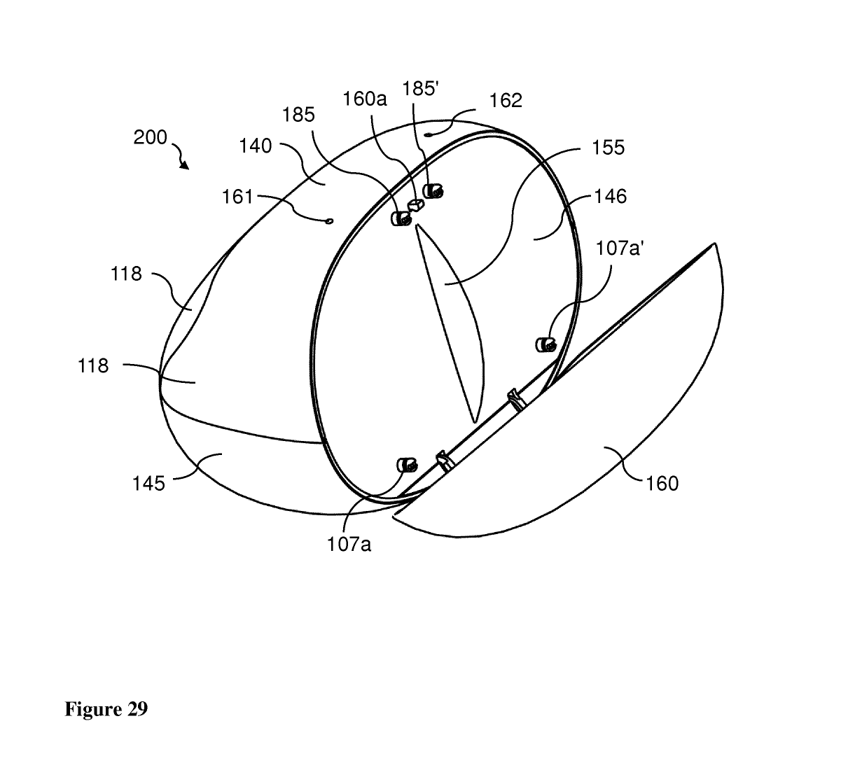

In FIG. 29, the cartridges 180, 180′ have been removed and the lid 160 is shown in an open position. In this position, the device 200 is ready for branching to new cartridges. A guiding wall 155 can be seen, which, together with wall 146, assists the correct positioning of the cartridge with respect to the device, accordingly, the evenness and contour of the wall 146, together with way wall 155 is arranged, allow only one possible way of placing the cartridges 180, 180′ to the device. In particular, cartridges 180, 180′ comprise only on flat wall part 220a that is arranged so as to be brought in vicinity or contact with wall 146 of the housing of the device 200. In FIG. 30, connectors 107a, 107a′, which connect to the liquid channeling system 104 are visible, as well as connectors or air passage opening structure 185 and 185′.

When the cartridge 180′ (FIGS. 30A-C) is branched to the device 200, the connector 185′ interact with opening 185b′. This branching opens an air duct allowing equilibrating pressure in the cartridge during liquid transfer. At the same time, connector 107a′ interacts with opening 107b′, so as to connect the inner lumen of the cartridge with the liquid channeling system 104.

As has been mentioned, the cartridge 180, 180′ is detachably connected and/or branched to the device of the invention. Preferably, the detachable connection is such that a user can detach and cbranch the cartridge 180, 180′ manually, without a special tool, and/or without exerting a lot of force. For example, a child should be able to remove the cartridge. On the other hand, the device and/or cartridge preferably contain a safeguard that prevents inadvertent detachment of the cartridge from the device. For example, the cartridge and the device may comprise a connection structure that allows a locking of the cartridge with respect to the device. For example, the cartridge may be fixed by way of a releasable click mechanism to the device, or may comprise a locking lever or locking pusher, that has to be actuated by the user in order to be able to remove the cartridge. In the embodiment shown in FIGS. 19-30, the lid 160 functions as safeguard for avoiding accidental dropping of the cartridges. In particular, the lid 160 is retained by a retainer structure 160a in a closed position. In particular, the retainer structure interacts with a structure on the lid (preferably on the inside), which keeps the lid in the closed position. The closed lid 160 preferably confines the cartridges 180, 180′ to their position branched to the device, so that the latter cannot accidentally disconnect in spite of their detachable character.

FIG. 31 shows in some detail the liquid channeling system 104 of the embodiment shown in FIGS. 19-28. The four pumps 106a-106d of the pump block 106 are unidirectional pumps, wherein one pair of unidirectional pumps, 106a/b and 106c/d, is connected to the respective cartridge via the ducts in duct or channeling piece 202. On the top in FIG. 31, at the other side of the pumps 106a-d, the channeling piece 201 is connected to all pumps and leads to a single duct 104a, which leads to the cleaning tank (FIG. 27). The ducts in the channeling pieces or duct blocks 201 and 202 are shown as dashed lines. The pumps 106a-106d let liquid pass only when pumping liquid. When switched off and/or not pumping (inactive), these pumps are closed, which is why pumps 106a-106d function also as valves, preventing mixing of different liquids and controlling liquid flow.

In an embodiment, the pumps of the device of the invention function as valves.

Pumps 106a and 106b are branched to cartridge 180 via tube or duct 204d, while pumps 106c and 106d are branched to cartridge 180′ via tube or duct 204d′. Accordingly, duct 204d is branched via a tube to connection assembly 107 (FIGS. 24 and 25), while duct 204d′ is branched via a tube to connection assembly 107′, in particular to connector 107a′ as discussed with respect to FIGS. 27 and 28.

As the skilled person will understand, a pair of pumps connected to the same cartridge can be replaced by a single bidirectional pump, as shown with respect to FIGS. 1, 7 and 8. In this case, the channeling piece 202 could be omitted, with each of the two bidirectional pumps being directly branched to the respective connector 107a, 107a′ or connection assembly 107, 107′. Pieces 201 and 202 are shown as rectangular blocks, but can be replaced by any type of branch connection, for example a Y- or three-way connection having a similar configuration as the three-way valve 50 in FIG. 16, but lacking any valve.

In FIG. 31, the pumps 106a-106b are arranged as pumps 6a-6b′ in FIG. 5b. Indeed, the liquid channeling system 4 in FIG. 5a is substantially equivalent to the one shown in FIG. 31.

Herein below, preferred embodiments of the invention are set out.

In an embodiment, the device of the invention comprises one or more valves 5, 50, 51, 5′, 50′, 51′ for controlling a flow of the cleaning liquid into and out of said tank. In an embodiment, said pumps, when active, pumps liquid through at least one duct of said liquid channeling system, and when inactive, closes said duct and thereby functions as a valve 5, 50, 51, 5′, 50′, 51′ of said liquid channeling system.

In an embodiment, the device comprises a cleaning tank comprising a single opening 3 through which liquids can enter and exit the cleaning tank. Preferably, the different types of liquids, such as the cleaning liquid, the rinsing liquid and/or the drying liquid, as applicable, enters the tank through said single opening 3.

In an embodiment, the device of the invention comprises one or more electronic controller 11 for operating said ultrasonic generator, said one or more pumps and/or said one or more valves.

In an embodiment, said cleaning tank, said one or more ultrasonic generator 10a, 10a′, 10b, said one or more fluid channeling system 4, 4′, 104, said one or more pumps 6, 6a, 6b, 6′, 6a′, 6b′, 106a-106d, and, optionally, said electronic controller 11, are housed inside said casing and/or housing. Preferably, said generator ultrasonic generator, said channeling system, said pumps, and, optionally, said electronic controller, are housed completely inside said housing. Preferably, they are not visible to the user from the outside of the device, unless said housing is transparent or comprises transparent components.

In an embodiment, the device is adapted to be branched to two separate cartridges 8, 8′; 180, 180′ containing, respectively, a first liquid 9a and a second liquid 9b, or to a single cartridge 80 comprising two separate compartments containing, respectively, said first and second liquids. Preferably, said first liquid is a cleaning liquid and said second liquid is a rinsing and/or drying liquid.

In an embodiment, the device of the invention is adapted to be branched and/or connected to one or more removable and/or detachable cartridges. Preferably, said one or more cartridges are manually removable. Preferably, a user can remove the cartridge without the need of any particular tool, such as a screwdriver or wrench, for example, a specially adapted tool.

In an embodiment, said cartridges are selected from disposable cartridges, recyclable cartridges, reusable cartridges, refillable cartridges and consumables.

In an embodiment, the housing and/or casing of the device comprises geometrical forms and/or surfaces that are complementary to at least part of the form of said cartridge, so as to guide or warrant correct positioning of the cartridge with respect to the device when said cartridge is removably branched and/or connected to the device. In an embodiment, said geometrical forms of the device comprise one or more receptacle for said one or more cartridges. Preferably, said geometrical forms and/or said receptacle receive and house said one or more cartridges when branched to the device.

In an embodiment, said geometrical forms and/or said receptacle is accurately fitting at least part of the form of said cartridge, and wherein said cartridge can only be positioned in one possible way when being branched and/or connected to the device.

In an embodiment, said geometrical forms and/or said receptacle accurately encase at least part of the form of said cartridge.

In an embodiment, said one or more cartridges are entirely housed within said housing. Preferably, said one or more cartridges, when branched and/or connected to said device, is supported and/or housed partially or completely inside the housing and/or casing of said device.

In an embodiment, the device of the invention comprises a door, lid and/or cover, which can be opened by a user for connecting a cartridge 180, 180′ to the device and branching it to said liquid channeling system, and for removing a cartridge for disconnecting it from the device. Preferably, opening of said lid gives access to the inside of said housing and/or to said geometrical forms and/or to said receptacle.

In an embodiment, the casing and/or housing of the device of the invention comprises one or more selected from a door, lid and/or cover 160 through which a user can access said cartridges 8, 8′, 80, 180, 180′ receivable by said casing and/or housing for adding or removing said cartridges from said casing and/or housing, thereby connecting and/or disconnecting, respectively, said one or more cartridge from said liquid channeling system.

In an embodiment, said cartridge, when branched and or connected to said device, and with the lid of the cartridge being closed, is not visible from the outside and/or is completely covered.

In an embodiment of device of the invention, said fluid channeling system is adapted to connect to openings of said cartridges 8, 8′, 80, 180, 180′.

In an embodiment, the device of the invention comprises a connector 7a, 7a′, 107a, 107a′ suitable to connect the device of the invention to a cartridge 8, 8′, 80, 180, 180′ comprising said cleaning and/or rinsing liquid.

Preferably, said one or more connectors 7a, 7a′, 107a, 107a′ are suitable to connect one or more ducts of said liquid channelling system of the device to an opening of said one or more cartridge 8, 8′, 80, 180, 180′ comprising said liquid. Preferably, said one or more connectors can be manually connected to said opening. Preferably, when the cartridge is connected and/or branched to the device of the invention, said connector engages and/or connects to said opening.

In an embodiment, the device of the invention comprises a connector 7a, 7a′, suitable to connect the device to one or more cartridge 8, 8′, 80, 180, 180′ as defined elsewhere in this specification.

In an embodiment, the device of the invention comprises a connector adapted to match an opening of said one or more cartridges so as to form a manually separable plug-and-socket connection assembly with said opening.

In an embodiment, the device of the invention comprises a connector forming a connection assembly with an opening in said cartridge, said connection assembly comprising complementary male and female tubular parts, wherein, with the cartridge being connected to the device, said complementary tubular parts connect the liquid content of the cartridge with the liquid channeling system of the device.

In an embodiment, the device of the invention comprises a connector 7a, 7a′, 107a, 107a′ adapted to connect said fluid channelling system in a water tight manner to an opening 7b, 7b′, 107b, 107b′ of said cartridge.

In an embodiment, the device of the invention comprises one or more connector 7a, 7a′, adapted to reversibly and/or detachably connect one or more ducts of said duct system to said cartridge.

In an embodiment, the one or more connector 7a, 7a′ comprises a clip mechanism for connecting to the connector to said cartridge.

In an embodiment of the device of the invention, said cartridge comprises an opening and/or connector 7b, 7b′ comprising a self-closing valve.

In an embodiment of the device of the invention, said connector is adapted to act upon and open a valve in said cartridge, so as to connect to liquid in the cartridge with the lumen of the liquid channeling system.

In an embodiment of the device of the invention, the connector 7a, 7a′ comprises a protruding structure adapted to interact with a valve provided on an opening 7b, 7b′ of said cartridge, wherein said protruding structure is arranged so as to open said valve with the connector 7a, 7a′, being connected with said opening.

In an embodiment, the device of the invention comprises one or more auxiliary connectors, adapted to be connected, preferably manually and/or detachably connected, to a pressure balancing opening in each of said one or more cartridge or said one or more compartments of a single cartridge.

In an embodiment, the device of the invention comprises a second, auxiliary or air-duct connector, which is adapted to connect to said cartridge when branched to the device, said auxiliary connector comprising an opening for letting pass a gas, such as air.

In an embodiment of device of the invention, an opening 7b, 7b′ of said cartridge comprises a resilient element, said resilient element acting on a closure of said opening so as to keep said opening closed, wherein said protruding structure of said connector 7a, 7a′ is adapted to act on said resilient element so as to prevent the resilient element from keeping said opening closed.

In an embodiment of device of the invention, said connector 7a, 7a′ comprises a first entity adapted to engage with a second entity provided on the opening 7b, 7b′ of said cartridge, so as to form a releasable connection assembly, preferably a clip mechanism, with said second entity.

In an embodiment of device of the invention, said one or more pumps comprise one or more bidirectional pumps 6, 6′.

In an embodiment of device of the invention, said tank 2, 2a, 102 comprises a bottom surface 14, said bottom surface comprising a surface that is inclined so as to form positions with lesser depths and positions with comparatively deeper depths in said tank, wherein and/or one or more inlet and outlet openings 3, 3′ are provided at the position of deepest depth of said tank.

In an embodiment of device of the invention, said fluid channelling system connects the outlet or inlet opening 3, 3′ in said tank 2, 2a, 102 to the connector 7a, 7a′, wherein said one or more valve is arranged to open and/or close one or more ducts of said liquid channelling system, and wherein said one or more ducts of said fluid channelling system is transported through and/or by a bidirectional pump 6, 6′ adapted to pump one or more cleaning liquids 9a, 9b through said duct and/or fluid channelling system.

In an embodiment, the device of the invention comprises two at least partially separate ducts 4b, 4c (FIG. 3, 4, 8) and/or two separate fluid channelling systems 4, 4′ (FIG. 5, 6, 7) for transporting two different liquids 9a, 9b into said cleaning tank.

In an embodiment of the device of the invention, two separate ducts 4b, 4c, 4b′, 4c′ of a fluid channelling system 4, 4′ are connected at a valve 50, 50′, said valve being connected to said inlet and/or outlet opening 3, 3′ via a common duct 4a, 4a′.

In an embodiment of the device of the invention, said one or more fluid channeling system 4, 4′ comprises a duct 4a, 4b, 4d connected to a connector 7a, adapted to be connected to an opening 7b, 7b′ of a cartridge 8, 8′, 80, 180, 180′. In an embodiment, said duct 4a, 4b, 4d is connected to a pump 6, 6a adapted to pump a liquid through said duct into a cleaning tank 2, 2a, 102. Preferably, the device comprises a valve adapted to close said duct and/or duct system.

In an embodiment of the device of the invention, said one or more fluid channelling system 4, 4′, 104 comprises a first duct 4a, 4b, 4d, 204d and a second duct 4a′, 4c, 4d′, 204d′, wherein said first duct is connected to a first connector 7a, 107a and said second duct is connected to a second connector 7a′, 107a′, wherein said first and second connectors, respectively, are adapted to be connected to a first and a second openings 7b, 7b′ 107b, 107b′ of two separate cartridges 8, 8′, 180, 180′ or of two separate compartments 81, 82 of a single cartridge 80. In an embodiment, said first duct 4a, 4b, 4d is connected to a first pump 6, 6a adapted to pump a liquid through said first duct, and/or said second duct 4a′, 4c, 4d′ is connected to a second pump 6′, 6a′, 6b adapted to pump a liquid through said second duct.

In an embodiment of the device of the invention, said liquid channeling system comprises one or more flexible tubes, for allowing a displacement of the cleaning tank with respect to the housing of the device. In particular, said flexible tubes allow a displacement of the cleaning tank, for opening and closing the latter, preferably without disbranching and/or disconnecting said liquid channeling system from said tank and/or from said respective connector 7a, 7a′, 107a.

In an embodiment, the device of the invention comprises a tank opening 17 suitable for introducing an object into said tank 2, 2a, 102 the device further comprising a lid 18, 18a, 180 adapted to close the opening 17 and a closure mechanism 30 adapted to lock the lid in a closed position. In an embodiment, said closure mechanism is activated by said electronic controller 11.

In an embodiment, said closure mechanism is activated by said electronic controller 11 so as to lock the lid in a closed position when a cleaning liquid is present in said tank.

In an embodiment, said closure mechanism comprises an electromagnetic lock 31, 32.

In an embodiment, said lid 18, 18a is adapted to close said opening 17 water-tightly.

In an embodiment, the device of the invention comprises an electric motor and a lid, door or cover of the cleaning tank, wherein said electric motor is arranged so as to open and/or close said lid, door and/or cover is by an electric motor.

In an embodiment, the device of the invention comprises a displacement mechanism 190, adapted to displace said cleaning tank from said first position to said second position. Preferably, said displacement mechanism is actuated by an electric motor 175.

In an embodiment, said displacement mechanism 190 is adapted to linearly and/or rotationally displace said cleaning tank with respect to the housing, in order to open and close said cleaning tank.

In an embodiment, said displacement mechanism 190 is connected to the cleaning tank, or to a cleaning tank 102 assembly 121 comprising said cleaning tank, and to a support or to said housing of said device.

In an embodiment, the device of the invention comprises a displacement mechanism and an electric motor for actuating said displacement mechanism 190, wherein said displacement mechanism acts upon a lid and/or cover 118 of said cleaning tank 102 so as to open and close said cleaning tank.

In an embodiment, said displacement mechanism 190 comprises a plurality of levers connecting the cleaning tank assembly with said support or housing, so as to guide the movement of said cleaning tank assembly during opening and/or closing.

In an embodiment, said displacement mechanism comprises a pair of left and right lever assemblies moving simultaneously for opening and closing said cleaning tank.

The device of any one of the preceding claims, wherein said displacement mechanism is adapted to move said cleaning tank with respect to the housing for opening and/or closing said cleaning tank.

In an embodiment, said tank 2, 2a, 102 of the device of the invention has a reservoir capacity of 200 ml to 750 ml, preferably 250-600 ml, and most preferably 300-500 ml.

In an embodiment, the device of the invention is adapted to perform the cleaning method of as defined elsewhere in this specification.

The invention also concerns cartridges 8, 8′, 80, 180, 180′ for cleaning liquid 9, 9a, 9b for the cleaning device, preferably an ultrasonic cleaning device, and most preferably for the cleaning device of the invention. In an embodiment, the cartridge of the invention comprises one or more openings 7b, 7b′, 107b, 107b′ for connecting the cartridge with the device of any one of the preceding claims.

In a preferred embodiment, which applies to all cartridges as disclosed herein, the cartridge is generally a closed recipient, be it for the openings 7b, 7b′, 107b, 107b′, which are specifically designed for branching the cartridge to the liquid channeling system of the device and/or to provide an air passage opening. The cartridges thus generally lack a comparatively large top opening, which may allow a user to remove the contents of the cartridge or to fill the cartridge. The cartridges are not meant to be dissembled by a user. The openings are comparatively small in that they are preferably ≦2 cm², more preferably ≦1 cm² in surface, even more preferably ≦0.7 cm², and most preferably ≦0.5 cm², wherein this surface indicates the surface opening with a valve present in the cartridge, the valve being opened. In another embodiment, the above surface values indicate the surface opening with the valve being removed from the cartridge. As a whole, the cartridge is preferably a closed recipient, and its contents can preferably only be accessed via said one or more openings as specifically disclosed in this specification.

In an embodiment, the cartridge of the invention comprising a cleaning, rinsing and/or drying liquid, wherein said liquid is enclosed in water-proof and/or air proof manner within said cartridge, and is preferably hermetically enclosed in said cartridge.

In an embodiment, the cartridge comprises an opening, wherein liquid exits through said opening into the liquid channeling system of said device and enters from the liquid channeling system into the cartridge through said same opening, when the cartridge is branched to the device.

In an embodiment, said one or more openings, for example said two openings comprise valve opening structures 46, 47, complete.

In an embodiment, the cartridge of the invention comprises one or two compartments in which said cleaning and/or rinsing liquid is contained, wherein each compartment comprises at least one opening for liquid passage from the cartridge to the device, wherein said opening comprises a valve and/or valve closure 46.

In an embodiment, the valve is a self-closing valve.

In an embodiment, the valve is a check-valve, preferably a self-closing check valve.

In an embodiment, the valve is adapted to open said opening when said cartridge is branched to said device.

In an embodiment, the one or more valve is provided in a wall of the cartridge.

In an embodiment, the cartridge lacks any manually actuatable opening or closure. In particular, the cartridge lacks any opening that is intended to be opened by a user without any specific tool. For example, the cartridge lacks a hand-actuatable screw cap, tap closure and the like.

In an embodiment, the cartridge of the invention comprising a valve opening, adapted to be opened and closed, respectively, when said cartridge is branched to and disconnected from the device

In an aspect, the invention provides a cartridge 8, 8′, 80, 180, 180′ for cleaning liquid 9, 9a, 9b for an ultrasonic cleaning device, said cartridge comprising an opening 7b, 7b′ comprising a valve, said opening being adapted to be connected with the connector 7a, 7a′ of the device of the invention.

In a preferred embodiment, the cartridge of the invention comprises a single opening 7b, 7b′, 107b′ intended for liquid passage through said liquid channelling system. Preferably, liquid in the cartridge exits and enters the cartridge through the same opening 7b, 7b′, 107b′ in the cartridge. Preferably, the cartridge comprises a single opening 7b, 7b′, 107b′ for liquid passage from the cartridge to the cleaning tank and vice versa, when the cartridge is branched to the device of the invention.

In an embodiment, said valve is adapted to open said opening when the cartridge is branched to a connector of said device.

In an embodiment, said cartridge comprises one or more openings 7b, 7b′, 107b, 107b′, wherein said opening comprises a self-opening valve, said valve being adapted to open when the connector 7a, 7a′ is connected to said opening.

In an aspect, the invention provides a cartridge 8, 8′, 80, 180, 180′ for cleaning liquid 9, 9a, 9b for an ultrasonic cleaning device, said cartridge comprising one or more openings 7b, 7b′, for connecting the cartridge with the device of the invention.

In an embodiment, the cartridge comprises a compartment comprising one or two valve openings.

In an embodiment, the cartridge of the invention comprises a compartment comprising at least a second opening, said second opening being preferably an air passage opening. In an embodiment, said second opening comprises a valve as said first opening. Said compartment preferably defines a single inner lumen of the cartridge comprises a given liquid, such as a cleaning or a rinsing liquid, for example.

In an embodiment, the cartridge of the invention comprises a compartment comprising a first and a second opening, said first opening being provided at or in vicinity of the bottom of the cartridge and said second opening being provided on or in vicinity the top of said cartridge.

In an embodiment, the cartridge of the invention comprises a compartment first and a second opening, said first and second opening are distanced one with respect to the other, preferably being provided on opposed ends of said cartridge.

In an embodiment, the cartridge of the invention comprises a first and a second opening, or comprises a compartment comprising a first and a second opening, said first and second openings are separated by a distance, said distance being at least half, preferably at least ⅗, more preferably at least ¾ of the maximum linear extension of said cartridge. The “maximum linear dimension” of the cartridge is the length of the longest straight line that can be laid across the cartridge. If the cartridge was a sphere or ball, the “maximum linear extension” would be the diameter (2r) of the sphere. If the cartridge was a cuboid, the “maximum linear extension of the cartridge would be the space diagonal of the cuboid.

In an embodiment, the cartridge of the invention comprises comprising two or more wall parts. Preferably, said first and second openings are provided in the same wall part.

In an embodiment, the cartridge of the invention comprises comprising an even wall part, wherein at least one, preferably at least two openings are provided in said even wall part.

In an embodiment, the cartridge of the invention comprises one or more wall parts made from plastic. Preferably, the walls of the cartridge are essentially made from plastic.

In an embodiment, the cartridge of the invention comprises two wall parts, a first and a second wall part, said two wall parts being connected in a water-proof manner so as to define a inner volume 290 of said cartridge.

Preferably, the wall parts of the cartridge of the invention are connected by any one or more selected from gluing, sealing and/or welding. Preferably, the wall parts are rigidly and/or permanently connected. Preferably, the connection of the wall parts is not intended to be separated, for example manually or with a particular tool.

In an embodiment, the cartridge of the invention comprises two wall parts, a flat wall part and a curved wall part, said wall parts being connected so as to define a inner volume 290 of said cartridge.

In an embodiment, the cartridge of the invention, the cartridge comprises geometrical forms adapted to be received in or on a housing of said device. Preferably, said cartridge comprises geometrical forms that are complementary to geometrical forms of the device, so as to allow accurate positioning of the cartridge when branching the latter to the device.

In an embodiment, said cartridge comprises two separate compartments 81, 82, a first compartment 81 and a second compartment 82, wherein said first and second compartments comprise different liquids 9a, 9b.

In an embodiment, the cartridge 8, 8′, 80, 180, 180′ of the invention comprises one or more compartments, wherein each of said compartment has a volume in the range of 200 ml to 750 ml, preferably 250-600 ml, and most preferably 300-500 ml.

In an embodiment, said wherein said first liquid/compartment comprises water and one or more cleaning agent and said second liquid/compartment comprises water and an alcohol.

In an aspect, the invention provides a method for cleaning glasses or other objects, the method comprising the steps of: pumping a cleaning liquid 9, 9a, 9b through one or more fluid channeling system 4, 4′ or duct into a cleaning tank 2, 2a, 102 of an ultrasonic cleaning device 1, 100, 101, 101′, 103, 110, 111, 200 comprising an object to be cleaned; applying an ultrasonic treatment so as to clean said object; pumping said cleaning liquid out of said cleaning tank.

In an embodiment of the method of the invention, said cleaning liquid is pumped from a cartridge 8, 8′, 80, 180, 180′ through said one or more fluid channeling system 4, 4′ or duct into said cleaning tank and/or said cleaning liquid is pumped back into a said cartridge when being pumped out of said tank.

In an embodiment, the method of the invention comprises the step of closing a valve 5, 50, 51, 5′, 50′, 51′ after the step of pumping said cleaning liquid into said tank 2, 2a.

In an embodiment of the method of the invention, said cleaning liquid is a first liquid 9a, and wherein said method further comprises the steps of: pumping a second liquid 9b into said cleaning tank so as to expose the object to be cleaned to said second liquid; and, pumping said second liquid out of said cleaning tank.

In an embodiment, the invention provides a cleaning liquid, for example liquid 9 (FIGS. 1-4). The invention also provides a cartridge 8, 8′, 80, 180, 180′ comprising the cleaning liquid 9. The cartridge may be as described elsewhere in this specification, in particular with respect to any one of Fogs 1 to 8, for example.

The cleaning liquid 9 may also be considered as the first liquid 9a, for example if the liquid is contained in a cartridge 80 comprising two compartments or if the device of the invention is adapted to be connected to two separate cartridges 8, 8′.

The cleaning liquid 9, 9a preferably comprises water and a cleaning agent. The water is preferably demineralized. The cleaning agent may be acid-based, alkaline or neutral. Preferably, the cleaning agent is alkaline, such as NaOH or NH₃, for example. The cleaning agent may comprise soap. The cleaning agent may be added as a mixture of cleaning agents, such as a liquid concentrate to the water, for example as a commercially available cleaning agent.

The cleaning liquid may preferably comprises one or more surfactants. The surfactant may be present in and/or as part of the cleaning agent, for example of the liquid concentrate cleaning agent. If the cleaning agent does not contain a surfactant, the surfactant may be added as such.

In an embodiment, the cleaning liquid 9, 9a comprises one or more anti-fog agents. The anti-fog agent has the purpose of preventing condensation of water on the surface of glasses cleaned with the device of the invention. For example, glycerol may be used as anti-fog agent. Preferably, the anti-fog agent is present at a concentration of 0-1 wt % of the cleaning liquid. In an embodiment, a mixture of anti-fog agents is present.

In a preferred embodiment, the cleaning liquid 9, 9a comprises water (preferably demineralized) acting as a solvent, a cleaning agent selected from acid-based, alkaline or neutral cleaning agents, preferably an alkaline cleaning agent. Preferably, a surfactant is present, for example as part of a cleaning agent concentrate. Furthermore, an anti-fog agent, for example glycerol is also present.

For example, a liquid concentrate cleaning agent is added at 0.5 to 7 wt. %, preferably 1-5 wt %, most preferably 2-3 wt. %. The surfactant, if present, may be added at 0.05 to 1.5 wt %, preferably 0.1 to 1 wt %, most preferably 0.2 to 0.9 wt %, for example 0.3 wt %. The anti-fog agent is may be added at a concentration of ≦0.9 wt %, for example 0.4 wt %.

The present invention provides a rinsing and/or drying solution 9b. The rinsing solution preferably comprises water and a high volatility solvent, such as alcohol, preferably isopropanol. Preferably, the rinsing agent comprises water and 0.5 to 6% alcohol, preferably isopropanol. More preferably, the rinsing agent comprises water and 1 to 4% alcohol, more preferably 1 to 3 wt % alcohol. Preferably, the water is not demineralized.

In an embodiment, the rinsing liquid 9b further comprises a surfactant. The surfactant may be present, for example, at the same concentration as specified above with respect to the washing liquid.

It was mentioned above that the cleaning liquid may comprise an anti-fog agent such as glycerol. In an embodiment, the cleaning liquid is free of an antif-fog agent such as glycerol but instead the rinsing liquid comprises an anti-fog agent, such as glycerol, at the same concentrations as specified above with respect to the cleaning liquid 9, 9a.

In an embodiment, the invention provides a cartridge comprising a cleaning liquid 9a and a rinsing or a drying liquid 9b. In an embodiment, the invention provides a cartridge comprising two compartments, one compartment comprising a cleaning liquid 9a and the other compartment comprising a rinsing/drying liquid 9b. The cleaning and the rinsing liquids may be as defined elsewhere in this specification, in particular as defined herein above. The cleaning liquid preferably comprises water as solvent (preferably demineralized), a cleaning agent, and, optionally, an anti-fog agent. The rinsing liquid preferably comprises water as a solvent (preferably non-demineralized), an alcohol (0.5 to 6%), and optionally an anti-fog agent, for example if an anti-fog agent such as glycerol is absent in the cleaning solution.

The cleaning and/or rinsing liquid preferably comprise a coloring agent.

In an embodiment, the cleaning and/or the rinsing liquid comprise a perfume.

Preferably the rinsing liquid comprises a perfume.

### LEGEND OF REFERENCE NUMBERS IN THE FIGURES

1, 100, 101, 101′,
103, 110, 111, 112, 200 device of the invention (apparatus)
2, 2a, 102 recipient for glasses/cleaning tank
3, 3′ opening for cleaning and/or drying liquid
4 liquid channeling system or duct system
4a, 4b, 4c, 4d
4a′, 4b′, 4c′, 4d′ tube or duct of duct system
5, 50, 51, 5′, 50′, 51′ valves
6, 6a, 6b, 6′, 6a′, 6b′ monodirectional and/or bidirectional pumps
7, 7′ connection assembly
7a, 7a′ connectors
7b, 7b′ openings/closures of cartridge
8, 8′, 80, 180, 180′ cartridge for cleaning and/or drying agent
81, 82 compartment for cleaning and/or drying agent within cartridge
9 cleaning and/or drying and rinsing liquid
9a cleaning liquid
9b rinsing or drying liquid
10a, 10a′ ultrasonic transducer
10b ultrasonic unit
11 electronic controller
12 power supply
13 inner side wall of cleaning tank
14 bottom surface of cleaning tank
14a protective layer
15 lumen of cleaning tank
16 filter or mesh
17 opening of cleaning tank
18 lid
19, 19a articulation
20 cartridge wall
20 cartridge wall section
21, 22 power cable
23-28 electric and/or signal cables
30 closure mechanism
31 tank-part of closure 30
32 lid-part of closure 30
35 holder device, basket, insert
36 top rim of tank
37 grid or sieve of insert
38 flange of insert
40 housing
41, 41a air duct
42 air valve opening/pressure balancing opening
43 air
44, 45 valve interacting structure
46, 47 valve and/or valve closing structure, valve closure
48, 49 duct opening
50 space in housing provided and/or configured to receive cartridges.
51, 52 inner lumen of duct/liquid channeling system
53 open end of duct system 4, 4′ or of duct 4a, 4b, 4c
54, 54a open end of air duct
55a, 55b cartridge positioning and/or guiding structures
56, 57, 56′, 57′, 58
102 cleaning tank
103 opening of cleaning tank 102
104 liquid channeling and/or duct system
104a tube of duct system leading to tank
106 pump block comprising four unidirectional pumps
106a, 106b, 106c, 106d pumps of pump block 106
107′ connection assembly
107a′ connectors
107b′ openings/closures of cartridge
110a ultrasonic transducer
111 carrying plate for electronics
113a curved inner side wall of cleaning tank
113b even inner side wall of cleaning tank
117 opening of cleaning tank
118 cover or lid for cleaning tank 102
119, 119′ pivotal articulation of mechanism 190
121 cleaning tank assembly
122, 122′ pivotal articulation
136 upper rim of cleaning tank 102
137
140 housing
141, 142, 143 feet of device
145 bottom or support of the housing
146 separating wall of housing 140
147, 147′ left and right rear pivot supports
148, 148′ left and right front pivot supports
149 horizontal, transversal axle
155 cartridge positioning structure, complementary form
160 door or cover for cartridges
160a retaining structure, click mechanism part
161, 162 LEDs
163 recess
164 horizontal line
165, 165′ pivotal articulation of lid 160
170 object to be cleaned
175 electric motor
180′, 180 first and second cartridges of device
181′, 181 left and right lateral covers of cleaning tank
181b bottom part of cleaning tank cover
182, 182′ supports for cleaning tank
185′ air valve connection assembly
190 displacement mechanism for cleaning tank 102
191′, 191 left and right rear levers
192′, 192 left and right front levers
193′, 193 left and right connecting levers
194′, 194 left and right auxiliary levers
195′, 195, 196′, 196,
197′, 197, 198′, 198,
199′, 199, pivotal connections
201, 202 distributer/junction unit, block with junctions
203, 203′
204 tube, duct part of connection assembly
204d, 204d′ ducts of liquid channeling system, connected to cartridge 2 and 1, respectively.
205 tube of connector 107a′ for connecting to liquid channeling system
206 tube of connector for connecting with cartridge
220a, 220b, 220c walls of cartridge 180′
221 seal of walls
222 circumferential rim or projection
223 circumferential flange
224 flange of wall parts 220b/220c
237 tubular opening
238, 238a positioning and/or retaining structures/pins
239, 239′ valve opening
240a, 240b flexible element
244 valve interacting structure
246, 246′ valve closing structure
247 bottom rim of valve piece 248
248 valve piece
251 channel
290, 290′ inner lumen of cartridge

1-41. (canceled)

42: An ultrasonic cleaning device for glasses and other objects, wherein the device is adapted for domestic use, the device comprising:
a closable cleaning tank for placing the object to be cleaned, said cleaning tank comprising one or more inlet openings;
one or more ultrasonic generator, for producing ultrasonic waves in said cleaning tank;
one or more fluid channelling system, which is arranged so as to allow connecting the cleaning tank with a detachable cartridge comprising a cleaning liquid, wherein said device is arranged such as to allow manual connection of the cartridge to the device and removal of the cartridge from the device;
one or more pumps for pumping the liquid through said one or more fluid channelling system into and out of the tank;
one or more electronic controller for operating said ultrasonic generator and said one or more pumps; and
a housing.

43: The device of claim 42, wherein said ultrasonic generator, fluid channelling system, one or more pumps, and said electronic controller are housed inside said housing.

44: The device of claim 42, which comprises surfaces that are complementary to at least part of the form of said cartridge, so as to guide an accurate positioning of the detachable cartridge with respect to the device when said cartridge is detachably connected to the device.

45: The device of claim 44, wherein said fluid channeling system comprises a connector which is arranged such that when said cartridge is manually positioned with respect to said complementary surfaces of the device, said connector automatically connects to an opening in said cartridge.

46: The device of claim 42, wherein said fluid channelling system comprises a connector, adapted to be manually connectable to an opening in said cartridge, wherein said connector and said opening form a connection assembly comprising complementary male and female tubular parts, wherein, with the cartridge being connected to the device, said complementary tubular parts connect the liquid content of the cartridge with the liquid channeling system of the device.

47: The device of claim 46, wherein said connector is adapted to act upon and open a valve in said cartridge, so as to connect to liquid in the cartridge with a lumen of said liquid channeling system.

48: The device of claim 42, comprising one or more auxiliary connectors, adapted to be connected in a manually detachable manner to a pressure balancing opening in said cartridge.

49: The device of claim 42, comprising a tank displacement mechanism arranged to allow a movement of the tank from a first position to a second position while remaining connected to said device, wherein, in said first position, the tank is closed and a user cannot access to the inside of the tank, and wherein in said second position, an opening to the tank is generated, allowing a user to put an object to be cleaned into said tank or remove a cleaned object from said tank.

50: The device of claim 49, wherein said displacement mechanism is actuated by an electric motor.

51: The device of claim 49, wherein said displacement mechanism is adapted to displace said cleaning tank in a manner selected from the group consisting of: linearly, rotationally and a combination of linearly and rotationally, with respect to the housing, in order to open and close said cleaning tank.

52: The device of claim 42, wherein said cartridge comprising said cleaning liquid is a first cartridge, and wherein said device is arranged to be connected to a second cartridge comprising a rinsing liquid.

53: A cartridge comprising one or both selected from a cleaning and a rinsing liquid for an ultrasonic cleaning device, said cartridge comprising an opening for connecting the cartridge with said cleaning device, wherein said opening comprises a self-closing valve.

54: The cartridge of claim 53, wherein said self-closing valve is a check valve.

55: The cartridge of claim 53, wherein said valve is provided in a wall of said cartridge.

56: The cartridge of claim 53, wherein said opening is a first opening and wherein said cartridge comprises a second opening, said second opening being an air passage opening.

57: The cartridge of claim 56, wherein said first and second openings are distanced one with respect to the other, preferably being provided on opposed ends of said cartridge.

58: The cartridge of claim 56, wherein said first and second openings are separated by a distance, said distance being at least half, preferably at least ⅗, more preferably at least ¾ of the maximum linear extension of said cartridge.

59: The cartridge of claim 53, which comprises one (1) or no (0) axis of symmetry.

60: The cartridge of claim 53, which is enantiomorph.

61: The cartridge of claim 53, comprising two wall parts, a first wall part and a second wall part, said two wall parts being connected in a water-proof manner so as to define a inner volume of said cartridge.

62: The cartridge of claim 53, which is selected from disposable cartridges, recyclable cartridges, reusable cartridges, refillable cartridges and consumables.

63: The cartridge of claim 53, which comprises at least two compartments, a first compartment comprising said cleaning liquid and a second compartment comprising said rinsing liquid.

64: A kit comprising two cartridges, a first cartridge and a second cartridge according to claim 53, wherein said first cartridge comprises an aqueous solution of one or more a cleaning agent and said second compartment comprises an aqueous solution comprising an alcohol.
